(19) United States
(12) Patent Application Publication
(10) Pub. No.: US 2022/0146891 A1
(43) Pub. Date: May 12, 2022

(54) OPTICAL ELEMENT AND METHOD OF MANUFACTURING OPTICAL ELEMENT

(71) Applicant: FUJIFILM Corporation, Tokyo (JP)

(72) Inventors: Hiroshi SATO, Minamiashigara-shi (JP); Katsumi SASATA, Minamiashigara-shi (JP); Yukito SAITOH, Minamiashigara-shi (JP); Keisuke KODAMA, Minamiashigara-shi (JP)

(73) Assignee: FUJIFILM Corporation, Tokyo (JP)

(21) Appl. No.: 17/584,093

(22) Filed: Jan. 25, 2022

Related U.S. Application Data
(63) Continuation of application No. PCT/JP2020/028485, filed on Jul. 22, 2020.

(30) Foreign Application Priority Data
Jul. 26, 2019 (JP) 2019-137693

(51) Int. Cl. G02F 1/1337; G02F 1/137

(52) U.S. Cl. CPC G02F 1/133788; G02F 1/133707; G02F 1/13718

(57) ABSTRACT

Provided is a method of manufacturing an optical element and an optical element, in which an alignment pattern can be formed with high manufacturing efficiency and high accuracy, an increase in manufacturing time caused by an increase in size can be suppressed, and a liquid crystal compound can be appropriately aligned. The method is a method of manufacturing an optical element, the optical element including a liquid crystal layer that is formed of a liquid crystal composition including a liquid crystal compound, an alignment film that aligns the liquid crystal compound of the liquid crystal layer, and a support, the method including: an alignment film forming step of forming the alignment film having a periodic unevenness shape on the support, the unevenness shape having a tilted surface that is tilted with respect to a surface of the support; and a liquid crystal layer forming step of forming the liquid crystal layer on the alignment film.

### CROSS-REFERENCE TO RELATED APPLICATIONS

This application is a Continuation of PCT International Application No. PCT/JP2020/028485 filed on Jul. 22, 2020, which claims priority under 35 U.S.C. § 119(a) to Japanese Patent Application No. 2019-137693 filed on Jul. 26, 2019. The above application is hereby expressly incorporated by reference, in its entirety, into the present application.

### BACKGROUND OF THE INVENTION

### 1. Field of the Invention

The present invention relates to an optical element and a method of manufacturing an optical element.

### 2. Description of the Related Art

As an example of a diffraction element that diffracts light, a liquid crystal diffraction element including a cholesteric liquid crystal layer obtained by immobilizing a cholesteric liquid crystalline phase is proposed.

For example, WO2016/194961A discloses a reflective structure comprising: a plurality of helical structures each extending in a predetermined direction; a first incident surface that intersects the predetermined direction and into which light is incident; and a reflecting surface that intersects the predetermined direction and reflects the light incident from the first incident surface, in which the first incident surface includes one of end portions in each of the plurality of helical structures, each of the plurality of helical structures includes a plurality of structural units that lies in the predetermined direction, each of the plurality of structural units includes a plurality of elements that are helically turned and laminated, each of the plurality of structural units includes a first end portion and a second end portion, the second end portion of one structural unit among structural units adjacent to each other in the predetermined direction forms the first end portion of the other structural unit, alignment directions of the elements positioned in the plurality of first end portions included in the plurality of helical structures are aligned, the reflecting surface includes at least one first end portion included in each of the plurality of helical structures, and the reflecting surface is not parallel to the first incident surface.

A reflective structure (cholesteric liquid crystal layer) described in WO2016/194961A has a liquid crystal alignment pattern in which a direction of an optical axis derived from the liquid crystal compound changes while continuously rotating in at least one in-plane direction. The cholesteric liquid crystal layer described in WO2016/194961A has the above-described liquid crystal alignment pattern so as to include the reflecting surface that is not parallel to the first incident surface.

A general cholesteric liquid crystal layer reflects incident light by specular reflection.

On the other hand, the reflective structure described in WO2016/194961A reflects incident light with an angle in the predetermined direction with respect to specular reflection instead of specular reflection. For example, in the cholesteric liquid crystal layer described in WO2016/194961A, light incident from the normal direction is reflected with an angle with respect to the normal direction instead of being reflected in the normal direction.

In addition, JP2010-525394A discloses a polarization diffraction grating including a substrate and a first polarization diffraction grating layer on the substrate. The first polarization diffraction grating layer includes a molecular structure that is twisted according to a first twist sense over a first thickness defined between opposing faces of the first polarization diffraction grating layer.

### SUMMARY OF THE INVENTION

In order to prepare a cholesteric liquid crystal layer having a liquid crystal alignment pattern in which a direction of an optical axis derived from a liquid crystal compound changes while continuously rotating in at least one in-plane direction, WO2016/194961A describes that an alignment film for aligning a liquid crystal compound to a predetermined alignment pattern is formed using a method such as a photoalignment method of controlling an alignment direction by irradiation with polarized light or a rubbing method of controlling an alignment direction by rubbing a surface of the alignment film with cloth.

However, in a case where the predetermined alignment pattern is formed on the alignment film using the method such as the photoalignment method or the rubbing method, it is necessary to change the alignment direction depending on fine regions, the steps become complicated, and there is a problem in that the manufacturing efficiency is poor. In addition, in these methods, there is a problem in that it is difficult to accurately form the alignment direction that varies depending on fine regions.

In addition, JP2010-525394A describes that the alignment film is exposed or patterned using a coherent beam that is irradiated from a laser with orthogonal circular polarizations at a relatively small angle.

By periodically changing the interference state of the coherent beam (interference light), the polarization state of light with which the alignment film is irradiated can periodically change according to interference fringes. As a result, the alignment pattern where the alignment state periodically changes can be formed on the alignment film.

However, according to an investigation by the present inventors, it was found that, in a case where the size of an optical element increases, it is necessary to increase the beam diameter of the interference light, but the amount of light per unit area is weakened as the beam diameter increases. Therefore, the exposure time increases, the alignment restriction force of the formed alignment film is not sufficient, and there is a problem in that it is difficult to align the liquid crystal compound in the liquid crystal layer formed on the alignment film.

An object of the present invention is to solve the above-described problem of the related art and to provide a method of manufacturing an optical element and an optical element, in which an alignment pattern can be formed with high manufacturing efficiency and high accuracy, an increase in manufacturing time caused by an increase in size can be suppressed, and a liquid crystal compound can be appropriately aligned.

In order to achieve the object, the present invention has the following configurations.

[1] A method of manufacturing an optical element, the optical element including a liquid crystal layer that is formed of a liquid crystal composition including a liquid crystal compound, an alignment film that aligns the liquid crystal compound of the liquid crystal layer, and a support, the method comprising:

an alignment film forming step of forming the alignment film having a periodic unevenness shape on the support, the unevenness shape having a tilted surface that is tilted with respect to a surface of the support; and

a liquid crystal layer forming step of forming the liquid crystal layer on the alignment film.

[2] The method of manufacturing an optical element according to [1],

in which in the alignment film forming step, after applying an alignment material forming the alignment film to the support, the unevenness shape is transferred to the alignment material to form the alignment film having the unevenness shape.

[3] The method of manufacturing an optical element according to [1],

in which in the alignment film forming step, after forming a resin layer having the unevenness shape on the support, the alignment film is formed on the resin layer.

[4] The method of manufacturing an optical element according to any one of [1] to [3],

in which a period of the unevenness shape of the alignment film that is formed in the alignment film forming step is 0.1 μm to 50 μm.

[5] The method of manufacturing an optical element according to any one of [1] to [4],

in which a height of a protrusion portion of the unevenness shape of the alignment film is 0.05 μm to 20 μm.

[6] The method of manufacturing an optical element according to any one of [1] to [5],

in which a tilt angle of the tilted surface of the unevenness shape of the alignment film is 3° to 80°.

[7] The method of manufacturing an optical element according to any one of [1] to [6],

in which in the liquid crystal layer forming step, the liquid crystal composition includes the liquid crystal compound and a chiral agent, and a cholesteric liquid crystal layer is formed by cholesteric alignment of the liquid crystal compound.

[8] The method of manufacturing an optical element according to [7],

in which at least one chiral agent of the liquid crystal composition is any one selected from the group consisting of a chiral agent X in which a helical twisting power changes due to light irradiation and a chiral agent Y in which a helical twisting power changes due to a temperature change, and

the liquid crystal layer forming step includes a step of changing the helical twisting power of the chiral agent due to light irradiation or heating.

[9] An optical element comprising:

a support;

an alignment film that is formed on the support; and

a liquid crystal layer that is formed on the alignment film and is formed of a liquid crystal composition including a liquid crystal compound,

in which a surface of the alignment film on the liquid crystal layer side has a periodic unevenness shape having a tilted surface that is tilted with respect to a surface of the support,

the liquid crystal compound in the liquid crystal layer is tilted with respect to the surface of the support, and

in a cross-section of the liquid crystal layer observed with a scanning electron microscope, bright portions and dark portions derived from the liquid crystal layer are tilted with respect to a main surface of the liquid crystal layer opposite to the alignment film.

[10] The optical element according to [9],

in which the liquid crystal layer is a cholesteric liquid crystal layer obtained by cholesteric alignment of the liquid crystal compound.

[11] The optical element according to [9] or [10],

in which on the main surface of the liquid crystal layer opposite to the alignment film, a direction of a molecular axis of the liquid crystal compound changes while continuously rotating in one in-plane direction.

[12] The optical element according to any one of [9] to [11],

in which in a case where a retardation is measured in a direction tilted with respect to a normal direction and a normal line of the main surface of the liquid crystal layer opposite to the alignment film,

an angle between a direction in which a value of retardation is minimum in any one of a slow axis plane or a fast axis plane and the normal direction is 5° or more.

According to the present invention, it is possible to provide a method of manufacturing an optical element and an optical element, in which an alignment pattern can be formed with high manufacturing efficiency and high accuracy, an increase in manufacturing time caused by an increase in size can be suppressed, and a liquid crystal compound can be appropriately aligned.

### BRIEF DESCRIPTION OF THE DRAWINGS

FIG. 1 is a schematic diagram showing one step in an example of a method of manufacturing an optical element according to the present invention.

FIG. 2 is a schematic diagram showing one step in the example of the method of manufacturing an optical element according to the present invention.

FIG. 3 is a perspective view schematically showing a transfer mold used in the method of manufacturing an optical element according to the present invention.

FIG. 4 is a schematic diagram showing one step in the example of the method of manufacturing an optical element according to the present invention.

FIG. 5 is a schematic diagram showing one step in the example of the method of manufacturing an optical element according to the present invention.

FIG. 6 is a schematic diagram showing one step in the example of the method of manufacturing an optical element according to the present invention.

FIG. 7 is an enlarged cross-sectional view schematically showing a part of an example of an optical element according to the present invention manufactured in the method of manufacturing an optical element according to the present invention.

FIG. 8 is a diagram conceptually showing a cross-sectional SEM image of a liquid crystal layer in the optical element according to the present invention.

FIG. 9 is a schematic diagram showing one step in another example of the method of manufacturing an optical element according to the present invention.

FIG. 10 is a schematic diagram showing one step in the other example of the method of manufacturing an optical element according to the present invention.

FIG. 11 is a schematic diagram showing one step in the other example of the method of manufacturing an optical element according to the present invention.

FIG. 12 is an enlarged cross-sectional view schematically showing a part of another example of the optical element according to the present invention manufactured in the method of manufacturing an optical element according to the present invention.

FIG. 13 is a schematic diagram showing another example of an alignment film that is formed in the method of manufacturing an optical element according to the present invention.

FIG. 14 is a schematic plan view showing an air interface-side surface of a liquid crystal layer in the optical element according to the present invention.

### DESCRIPTION OF THE PREFERRED EMBODIMENTS

Hereinafter, a method of manufacturing an optical element and an optical element according to an embodiment of the present invention will be described in detail based on a preferable example shown in the accompanying drawings.

In the present invention, numerical ranges represented by “to” include numerical values before and after “to” as lower limit values and upper limit values.

In this present invention, “(meth)acrylate” represents “either or both of acrylate and methacrylate”.

In the present invention, Re(λ) represents an in-plane retardation at a wavelength λ. Unless specified otherwise, the wavelength λ, refers to 550 nm.

In the present invention, Re(λ) is a value measured at the wavelength λ using a polarization phase difference analysis device AxoScan (manufactured by Axometrics, Inc.). By inputting an average refractive index ((nx+ny+nz)/3) and a thickness (d (μm)) to AxoScan, the following expressions can be calculated.

Slow Axis Direction (°)

Re(λ)=R0(λ)

R0(λ) is expressed as a numerical value calculated by AxoScan and represents Re(λ).

In this present invention, the refractive indices nx, ny, and nz are measured using an Abbe refractometer (NAR-4T, manufactured by Atago Co., Ltd.), and a sodium lamp (λ=589 nm) is used as a light source. In addition, the wavelength dependence can be measured using a combination of a multi-wavelength Abbe refractometer DR-M2 (manufactured by Atago Co., Ltd.) and an interference filter.

In addition, as the refractive index, values described in “Polymer Handbook” (John Wiley&Sons, Inc.) and catalogs of various optical films can also be used. The values of average refractive index of major optical films are as follows: cellulose acylate (1.48), cycloolefin polymer (1.52), polycarbonate (1.59), polymethyl methacrylate (1.49), and polystyrene (1.59).

[Method of Manufacturing Optical Element]

The method of manufacturing an optical element according to the embodiment of the present invention is

a method of manufacturing an optical element, the optical element including a liquid crystal layer that is formed of a liquid crystal composition including a liquid crystal compound, an alignment film that aligns the liquid crystal compound of the liquid crystal layer, and a support, the method comprising:

an alignment film forming step of forming the alignment film having a periodic unevenness shape on the support, the unevenness shape having a tilted surface that is tilted with respect to a surface of the support; and

a liquid crystal layer forming step of forming the liquid crystal layer on the alignment film.

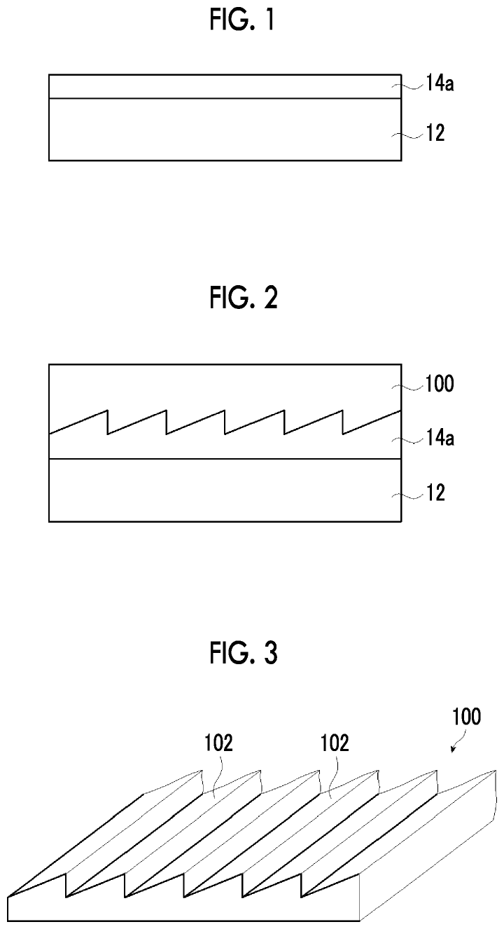

Hereinafter, an example of the method of manufacturing an optical element according to the embodiment of the present invention will be described using FIGS. 1 to 6.

The method of manufacturing an optical element shown in FIGS. 1 to 6 includes: a first application step of applying a coating solution forming an alignment film to a surface of a support; a transfer step of pressing a transfer mold having an unevenness shape against the coating film applied in the first application step to transfer the unevenness shape to the coating film; an alignment treatment step of aligning the alignment film having the unevenness shape after the transfer step; a second application step of applying a liquid crystal composition forming a liquid crystal layer to the alignment film having the unevenness shape; a heating step of heating the applied liquid crystal composition to align the liquid crystal compound; and a curing step of curing the liquid crystal composition to immobilize the alignment of the liquid crystal layer after the heating step.

Using this manufacturing method, an optical element 10 including a support 12, an alignment film 14, and a liquid crystal layer 16 as shown in FIG. 6 is prepared. The optical element 10 manufactured using the manufacturing method according to the embodiment of the present invention is used, for example, as a liquid crystal diffraction element.

In addition, the liquid crystal layer formed in the present invention is a cholesteric liquid crystal layer or a liquid crystal layer in which a liquid crystal compound is gently rotated and aligned in a thickness direction. In the following description, it is assumed that the liquid crystal layer is a cholesteric liquid crystal layer.

<First Application Step>

As shown in FIG. 1, the first application step is a step of applying a coating solution forming an alignment film to a surface of the support 12 to form a coating layer 14a. The coating layer 14a is an alignment film on which an unevenness shape is not yet formed.

For the application of the coating solution forming the alignment film, a printing method such as ink jet or scroll printing or a well-known method such as spin coating, bar coating, or spray coating capable of uniformly applying liquid to a sheet-shaped material can be used.

(Support)

As the support 12, various sheet-shaped materials can be used as long as they can support the alignment film 14 and the cholesteric liquid crystal layer 16.

A transmittance of the support 12 with respect to corresponding light is preferably 50% or higher, more preferably 70% or higher, and still more preferably 85% or higher.

The thickness of the support 12 is not particularly limited and may be appropriately set depending on the use of the optical element 10, flexibility or rigidity required for the optical element 10, a difference in thickness required for the optical element 10, and a material for forming the support 12, and the like in a range where the alignment film 14 and the cholesteric liquid crystal layer 16 can be supported.

The thickness of the support 12 is preferably 1 to 1000 μm, more preferably 3 to 250 μm, and still more preferably 5 to 150 μm.

The support 12 may have a monolayer structure or a multi-layer structure.

In a case where the support 12 has a monolayer structure, examples thereof include supports 12 formed of glass, triacetyl cellulose (TAC), polyethylene terephthalate (PET), polycarbonates, polyvinyl chloride, acryl, polyolefin, and the like. In a case where the support 12 has a multi-layer structure, examples thereof include a support including: one of the above-described supports having a monolayer structure that is provided as a substrate; and another layer that is provided on a surface of the substrate.

(Coating Solution Forming Alignment Film)

The coating solution forming the alignment film 14 is a composition including an organic compound that is a material for forming an alignment film.

As the material used for the alignment film 14, for example, a material for forming polyimide, polyvinyl alcohol, a polymer having a polymerizable group described in JP1997-152509A (JP-H9-152509A), or an alignment film 14 such as JP2005-97377A, JP2005-99228A, and JP2005-128503A is preferable.

In addition, it is also preferable to use a photo-alignment material as the material used for the alignment film 14.

Preferable examples of the photo-alignment material used in the alignment film that can be used in the present invention include: an azo compound described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B; an aromatic ester compound described in JP2002-229039A; a maleimide- and/or alkenyl-substituted nadiimide compound having a photo-alignable unit described in JP2002-265541A and JP2002-317013A; a photocrosslinking silane derivative described in JP4205195B and JP4205198B, a photocrosslinking polyimide, a photocrosslinking polyamide, or a photocrosslinking polyester described in JP2003-520878A, JP2004-529220A, and JP4162850B; and a photodimerizable compound, in particular, a cinnamate compound, a chalcone compound, or a coumarin compound described in JP1997-118717A (JP-H9-118717A), JP 1998-506420A (JP-H10-506420A), JP2003-505561A, WO2010/150748A, JP2013-177561A, and JP2014-12823A.

Among these, an azo compound, a photocrosslinking polyimide, a photocrosslinking polyamide, a photocrosslinking polyester, a cinnamate compound, or a chalcone compound is suitably used.

The thickness of the coating layer 14a is not particularly limited and may be appropriately set in a range where the unevenness shape can be appropriately transferred in the transfer step described below and an alignment function required for the alignment film 14 can be obtained.

The thickness of the coating layer 14a is preferably 0.05 μm to 100 μm and more preferably 0.1 μm to 10 μm.

<Transfer Step>

As shown in FIG. 2, the transfer step is a step of pressing a transfer mold 100 having an unevenness shape against the coating layer 14a applied in the first application step to transfer the unevenness shape to the coating layer 14a.

FIG. 3 is a schematic perspective view showing the transfer mold 100. As shown in FIG. 3, the transfer mold 100 has a periodic unevenness shape having a tilted surface in one in-plane direction. In the example shown in FIG. 3, in the transfer mold 100, protrusion portions 102 having a right angled triangular shape in cross-section that extend in a width direction are arranged in a direction perpendicular to the width direction. As a result, in a cross-section of the transfer mold 100 in the direction perpendicular to the width direction, a surface of the transfer mold 100 has a so-called saw toothed shape.

By pressing the transfer mold 100 against the coating layer 14a, the periodic unevenness shape having the tilted surface that is tilted with respect to a surface of the support 12 is formed (transferred) on the coating layer 14a (alignment film).

Accordingly, the unevenness shape formed in the transfer mold 100 may be a shape corresponding to a desired unevenness shape formed in the alignment film. The unevenness shape formed in the alignment film will be described below.

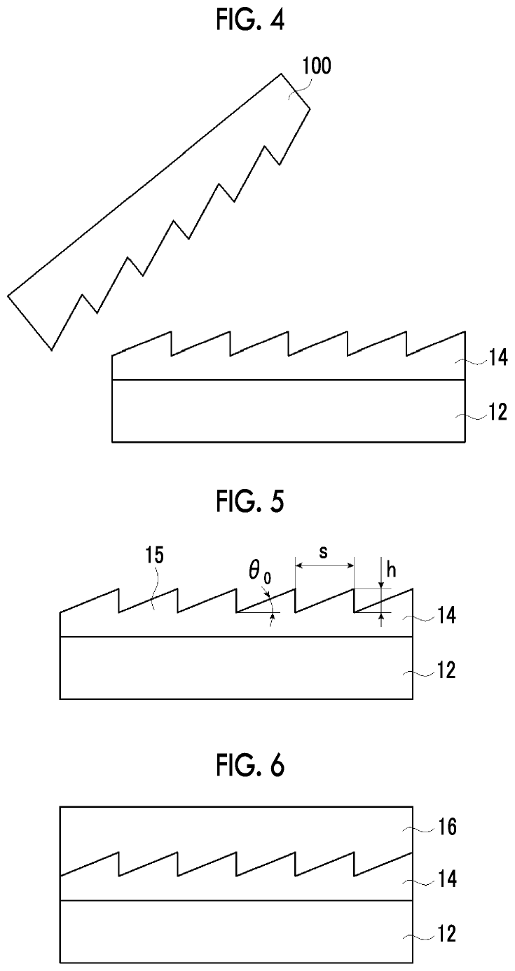

Further, after curing the coating layer 14a by heating or the like in a state where the transfer mold 100 is pressed, the transfer mold 100 is released (refer to FIG. 4). As a result, the alignment film 14 to which the unevenness shape is transferred is formed.

<Alignment Treatment Step>

The alignment treatment step is a step of aligning the alignment film having the unevenness shape after the transfer step. The first application step, the transfer step, and the alignment treatment step correspond to the alignment film forming step in the present invention.

The alignment treatment can be performed by a rubbing treatment and/or light irradiation.

In the rubbing treatment, the alignment film 14 can be formed by rubbing a surface of a polymer layer forming the alignment film 14 with paper or fabric in a given direction multiple times. A direction of the rubbing treatment is not particularly limited and may be a periodic direction of the unevenness shape formed in the alignment film 14, may be a direction (the width direction of the protrusion portion) perpendicular to the periodic direction, or may be a direction at a predetermined angle with respect to the periodic direction of the unevenness shape.

In a case where a photo-alignment material is used as the material for forming the alignment film, the alignment film 14 having the unevenness shape may be irradiated with polarized light or non-polarized light. The irradiation of polarized light can be performed in a direction perpendicular or oblique to the alignment film 14, and the irradiation of non-polarized light can be performed in a direction oblique to the alignment film. In addition, a direction of the alignment by light irradiation is not particularly limited and may be a periodic direction of the unevenness shape formed in the alignment film 14, may be a direction (the width direction of the protrusion portion) perpendicular to the periodic direction, or may be a direction at a predetermined angle with respect to the periodic direction of the unevenness shape.

As a result, the alignment film 14 having the unevenness shape is formed, in which a liquid crystal compound 40 on a surface on the alignment film 14 side in the cholesteric liquid crystal layer 16 formed on the alignment film 14 is arranged in one predetermined in-plane direction.

The liquid crystal compound 40 on the surface on the alignment film 14 side in the cholesteric liquid crystal layer 16 formed on the alignment film 14 is aligned to be parallel or perpendicular to the above-described direction of the alignment treatment.

The thickness of the alignment film 14 is not particularly limited. The thickness with which a required alignment function can be obtained may be appropriately set depending on the material for forming the alignment film 14.

The thickness of the alignment film 14 is preferably 0.01 to 5 μm and more preferably 0.05 to 2 μm.

FIG. 5 shows the alignment film 14 having the unevenness shape that is prepared in the transfer step and the alignment treatment step.

As shown in FIG. 5, the length of a protrusion portion 15 formed in the alignment film 14, that is, the period of the unevenness shape is represented by s, the height of the protrusion portion 15 is represented by h, and the tilt angle of the tilted surface of the protrusion portion 15 is represented by θ₀.

The period s of the unevenness shape of the alignment film 14 is preferably 0.1 μm to 50 μm, more preferably 0.2 μm to 10 μm, and still more preferably 0.25 μm to 5 μm.

In addition, the height h of the protrusion portion of the unevenness shape of the alignment film is preferably 0.05 μm to 20 μm, more preferably 0.1 μm to 10 μm, and still more preferably 0.15 μm to 5

In addition, the tilt angle θ₀ of the tilted surface of the unevenness shape of the alignment film is preferably 3° to 80°, more preferably 5° to 70°, and still more preferably 10° to 60°.

By adjusting the period s of the unevenness shape of the alignment film 14, the height h of the protrusion portion, and the tilt angle θ₀ of the tilted surface to be in the above-described ranges, the liquid crystal compound 40 in the cholesteric liquid crystal layer 16 formed on the alignment film 14 can be tilted with respect to the surface of the support 12, and in a cross-section (hereinafter also referred to as “cross-sectional SEM image”) of the cholesteric liquid crystal layer 16 observed with a scanning electron microscope (SEM), bright portions and dark portions derived from the cholesteric liquid crystal layer 16 can be tilted with respect to a main surface of the cholesteric liquid crystal layer 16 opposite to the alignment film 14.

<Second Application Step>

The second application step is a step of applying a liquid crystal composition forming the cholesteric liquid crystal layer 16 to the formed alignment film 14.

For the application of the liquid crystal composition, a printing method such as ink jet or scroll printing or a well-known method such as spin coating, bar coating, or spray coating capable of uniformly applying liquid to a sheet-shaped material can be used.

The thickness of the coating film of the liquid crystal composition is not particularly limited and may be appropriately set depending on the thickness of the formed cholesteric liquid crystal layer 16.

(Liquid Crystal Composition)

Examples of a material used for forming the cholesteric liquid crystal layer 16 obtained by immobilizing a cholesteric liquid crystalline phase include a liquid crystal composition including a liquid crystal compound and a chiral agent. It is preferable that the liquid crystal compound is a polymerizable liquid crystal compound.

In addition, the liquid crystal composition used for forming the cholesteric liquid crystal layer may further include a surfactant or the like.

—Polymerizable Liquid Crystal Compound—

The polymerizable liquid crystal compound may be a rod-shaped liquid crystal compound or a disk-shaped liquid crystal compound.

Examples of the rod-shaped polymerizable liquid crystal compound for forming the cholesteric liquid crystalline phase include a rod-shaped nematic liquid crystal compound. As the rod-shaped nematic liquid crystal compound, an azomethine compound, an azoxy compound, a cyanobiphenyl compound, a cyanophenyl ester compound, a benzoate compound, a phenyl cyclohexanecarboxylate compound, a cyanophenylcyclohexane compound, a cyano-substituted phenylpyrimidine compound, an alkoxy-substituted phenylpyrimidine compound, a phenyldioxane compound, a tolan compound, or an alkenylcyclohexylbenzonitrile compound is preferably used. Not only a low-molecular-weight liquid crystal compound but also a polymer liquid crystal compound can be used.

The polymerizable liquid crystal compound can be obtained by introducing a polymerizable group into the liquid crystal compound. Examples of the polymerizable group include an unsaturated polymerizable group, an epoxy group, and an aziridinyl group. Among these, an unsaturated polymerizable group is preferable, and an ethylenically unsaturated polymerizable group is more preferable. The polymerizable group can be introduced into the molecules of the liquid crystal compound using various methods. The number of polymerizable groups in the polymerizable liquid crystal compound is preferably 1 to 6 and more preferably 1 to 3.

Examples of the polymerizable liquid crystal compound include compounds described in Makromol. Chem., (1989), Vol. 190, p. 2255, Advanced Materials (1993), Vol. 5, p. 107, U.S. Pat. No. 4,683,327A, U.S. Pat. No. 5,622,648A, U.S. Pat. No. 5,770,107A, WO95/22586, WO95/24455, WO97/00600, WO98/23580, WO98/52905, JP1989-272551A (JP-H1-272551A), JP1994-16616A (JP-H6-16616A), JP1995-110469A (JP-H7-110469A), JP1999-80081A (JP-H11-80081A), and JP2001-328973A. Two or more polymerizable liquid crystal compounds may be used in combination. In a case where two or more polymerizable liquid crystal compounds are used in combination, the alignment temperature can be decreased.

In addition, as a polymerizable liquid crystal compound other than the above-described examples, for example, a cyclic organopolysiloxane compound having a cholesteric phase described in JP1982-165480A (JP-S57-165480A) can be used. Further, as the above-described polymer liquid crystal compound, for example, a polymer in which a liquid crystal mesogenic group is introduced into a main chain, a side chain, or both a main chain and a side chain, a polymer cholesteric liquid crystal in which a cholesteryl group is introduced into a side chain, a liquid crystal polymer described in JP1997-133810A (JP-H9-133810A), and a liquid crystal polymer described in JP1999-293252A (JP-H11-293252A) can be used.

—Disk-Shaped Liquid Crystal Compound—

As the disk-shaped liquid crystal compound, for example, compounds described in JP2007-108732A and JP2010-244038A can be preferably used.

In addition, the addition amount of the polymerizable liquid crystal compound in the liquid crystal composition is preferably 75 to 99.9 mass %, more preferably 80 to 99 mass %, and still more preferably 85 to 90 mass % with respect to the solid content mass (mass excluding a solvent) of the liquid crystal composition.

—Surfactant—

The liquid crystal composition used for forming the cholesteric liquid crystal layer may include a surfactant.

It is preferable that the surfactant is a compound that can function as an alignment control agent contributing to the stable or rapid formation of a cholesteric liquid crystalline phase with planar alignment. Examples of the surfactant include a silicone-based surfactant and a fluorine-based surfactant. Among these, a fluorine-based surfactant is preferable.

Specific examples of the surfactant include compounds described in paragraphs “0082” to “0090” of JP2014-119605A, compounds described in paragraphs “0031” to “0034” of JP2012-203237A, exemplary compounds described in paragraphs “0092” and “0093” of JP2005-99248A, exemplary compounds described in paragraphs “0076” to “0078” and paragraphs “0082” to “0085” of JP2002-129162A, and fluorine (meth)acrylate polymers described in paragraphs “0018” to “0043” of JP2007-272185A.

As the surfactant, one kind may be used alone, or two or more kinds may be used in combination.

As the fluorine-based surfactant, a compound described in paragraphs “0082” to “0090” of JP2014-119605A is preferable.

The addition amount of the surfactant in the liquid crystal composition is preferably 0.01 to 10 mass %, more preferably 0.01 to 5 mass %, and still more preferably 0.02 to 1 mass % with respect to the total mass of the liquid crystal compound.

—Chiral Agent (Optically Active Compound)—

The chiral agent has a function of causing a helical structure of a cholesteric liquid crystalline phase to be formed. The chiral agent may be selected depending on the purpose because a helical twisted direction or a helical pitch derived from the compound varies.

The chiral agent is not particularly limited, and a well-known compound (for example, Liquid Crystal Device Handbook (No. 142 Committee of Japan Society for the Promotion of Science, 1989), Chapter 3, Article 4-3, chiral agent for twisted nematic (TN) or super twisted nematic (STN), p. 199), isosorbide (chiral agent having an isosorbide structure), or an isomannide derivative can be used.

In addition, the chiral agent in which back isomerization, dimerization, isomerization, dimerization or the like occurs due to light irradiation such that the helical twisting power (HTP) decreases can also be suitably used.

In general, the chiral agent includes an asymmetric carbon atom. However, an axially asymmetric compound or a planar asymmetric compound not having an asymmetric carbon atom can also be used as the chiral agent. Examples of the axially asymmetric compound or the planar asymmetric compound include binaphthyl, helicene, paracyclophane, and derivatives thereof. The chiral agent may include a polymerizable group. In a case where both the chiral agent and the liquid crystal compound have a polymerizable group, a polymer which includes a repeating unit derived from the polymerizable liquid crystal compound and a repeating unit derived from the chiral agent can be formed due to a polymerization reaction of a polymerizable chiral agent and the polymerizable liquid crystal compound. In this aspect, it is preferable that the polymerizable group in the polymerizable chiral agent is the same as the polymerizable group in the polymerizable liquid crystal compound. Accordingly, the polymerizable group of the chiral agent is preferably an unsaturated polymerizable group, an epoxy group, or an aziridinyl group, more preferably an unsaturated polymerizable group, and still more preferably an ethylenically unsaturated polymerizable group.

In addition, the chiral agent may be a liquid crystal compound.

In a case where the chiral agent includes a photoisomerization group, a pattern having a desired reflection wavelength corresponding to a luminescence wavelength can be formed by irradiation of an actinic ray or the like through a photomask after coating and alignment, which is preferable. As the photoisomerization group, an isomerization moiety of a photochromic compound, an azo group, an azoxy group, or a cinnamoyl group is preferable. Specific examples of the compound include compounds described in JP2002-80478A, JP2002-80851A, JP2002-179668A, JP2002-179669A, JP2002-179670A, JP2002-179681A, JP2002-179682A, JP2002-338575A, JP2002-338668A, JP2003-313189A, and JP2003-313292A.

Chiral Agent X in Which Helical Twisting Power Changes Due to Light Irradiation

The chiral agent X is a compound that induces the helix of the liquid crystal compound, and is not particularly limited as long as it is a chiral agent in which the helical twisting power (HTP) changes due to light irradiation.

In addition, the chiral agent X may be liquid crystalline or amorphous. In general, the chiral agent X has an asymmetric carbon atom. However, an axially asymmetric compound or a planar asymmetric compound not having an asymmetric carbon atom can also be used as the chiral agent X. The chiral agent X may include a polymerizable group.

Examples of the chiral agent X include a so-called photoreactive chiral agent. The photoreactive chiral agent is a compound including a chiral moiety and a photoreaction moiety of which the structure changes due to light irradiation and in which, for example, the twisting power of the liquid crystal compound changes depending on the amount of light irradiated.

Examples of the photoreaction moiety of which the structure changes due to light irradiation include a photochromic compound (Kingo Uchida, Masahiro Irie, Chemical Industry, Vol. 64, p. 640, 1999, and Kingo Uchida and Masahiro Irie, Fine Chemical, Vol. 28(9), p. 15, 1999). In addition, the above-described structure change refers to decomposition, addition reaction, isomerization, and dimerization reaction that is caused by light irradiation on the photoreactive moiety, and the structure change may be irreversible. In addition, the chiral moiety corresponds to an asymmetric carbon described in Chemistry of Liquid Crystal, No. 22, Hiroyuki Nohira, Chemistry Review, p. 73, 1994.

Examples of the photoreactive chiral agent include a photoreactive chiral agent described in paragraphs “0044” to “0047” of JP2001-159709A, an optically active compound described in paragraphs “0019” to “0043” of JP2002-179669A, an optically active compound described in paragraphs “0020” to “0044” of JP2002-179633A, an optically active compound described in paragraphs “0016” to “0040” of JP2002-179670A, an optically active compound described in paragraphs “0017” to “0050” of JP2002-179668A, an optically active compound described in paragraphs “0018” to “0044” of JP2002-180051A, an optically active compound described in paragraphs “0016” to “0055” of JP2002-338575A, and an optically active compound described in paragraphs “0020” to “0049” of JP2002-179682A.

In particular, it is preferable that the chiral agent X is a compound including at least one photoisomerization moiety. As the photoisomerization moiety, from the viewpoints that absorption of visible light is small, photoisomerization is likely to occur, and a difference in helical twisting power before and after light irradiation is large, a cinnamoyl moiety, a chalcone moiety, an azobenzene moiety, a stilbene moiety, a coumarin moiety is preferable, and a cinnamoyl moiety or a chalcone moiety is more preferable. The photoisomerization moiety corresponds to the above-described photoreaction moiety of which the structure changes due to light irradiation.

In addition, as the chiral agent X, from the viewpoint that a difference in helical twisting power before and after light irradiation is large, an isosorbide optically active compound, an isomannide optical compound, or a binaphthol optically active compound is preferable. That is, it is preferable that the chiral agent X has an isosorbide skeleton, an isomannide skeleton, or a binaphthol skeleton as the above-described chiral moiety. As the chiral agent X, from the viewpoint that a difference in helical twisting power before and after light irradiation is larger, an isosorbide optically active compound or a binaphthol optically active compound is more preferable, and an isosorbide optically active compound is still more preferable.

The helical pitch of the cholesteric liquid crystalline phase depends on the kind of the chiral agent X and the concentration thereof added. Therefore, a desired pitch can be obtained by adjusting the kind and the concentration of the chiral agent X.

As the chiral agent X, one kind may be used alone, or two or more kinds may be used in combination.

Chiral Agent XA

In a case where the chiral agent X is used in combination with a chiral agent (hereinafter, also referred to as “chiral agent XA”) that induces the helix in the opposite direction, the chiral agent XA is a compound that induces the helix of the liquid crystal compound, and is preferably a chiral agent in which the helical twisting power (HTP) does not change due to light irradiation.

In addition, the chiral agent XA may be liquid crystalline or amorphous. In general, the chiral agent XA has an asymmetric carbon atom. However, an axially asymmetric compound or a planar asymmetric compound not having an asymmetric carbon atom can also be used as the chiral agent XA. The chiral agent XA may include a polymerizable group.

As the chiral agent XA, a well-known chiral agent can be used. In a case where the liquid crystal composition includes one kind of the chiral agent X and the helical twisting power of the chiral agent X exceeds a predetermined range (for example, 0.0 to 1.9 μm⁻¹) in a state where the chiral agent X is not irradiated with light, it is preferable that the chiral agent XA is a chiral agent that induces the helix in the direction opposite to that of the above-described chiral agent X. That is, for example, in a case where the helix induced by the chiral agent X is the right direction, the helix induced by the chiral agent XA is the left direction.

In addition, in a case where the liquid crystal composition includes plural kinds of the chiral agents X as the chiral agent and the weighted average helical twisting power of the chiral agents X exceeds the above-described range in a state where the chiral agent X is not irradiated with light, it is preferable that the chiral agent XA is a chiral agent that induces the helix in a direction opposite to that of the weighted average helical twisting power.

Chiral Agent Y in Which Helical Twisting Power Changes Due to Cooling or Heating

The chiral agent Y is a compound that induces the helix of the liquid crystal compound, and is not particularly limited as long as it is a chiral agent in which the helical twisting power (HTP) increases due to cooling or heating. In addition, the upper limit of the temperature of cooling or heating is typically about ±150° C. (in other words, a chiral agent in which the helical twisting power increases due to cooling or heating at ±150° C. is preferable). In particular, a chiral agent in which the helical twisting power increases due to cooling is preferable.

The chiral agent Y may be liquid crystalline or amorphous. The chiral agent can be selected from various well-known chiral agents (for example, Liquid Crystal Device Handbook (No. 142 Committee of Japan Society for the Promotion of Science, 1989), Chapter 3, Article 4-3, chiral agent for twisted nematic (TN) or super twisted nematic (STN), p. 199). In general, the chiral agent Y has an asymmetric carbon atom. However, an axially asymmetric compound or a planar asymmetric compound not having an asymmetric carbon atom can also be used as the chiral agent Y. Examples of the axially asymmetric compound or the planar asymmetric compound include binaphthyl, helicene, paracyclophane, and derivatives thereof. The chiral agent Y may include a polymerizable group.

As the chiral agent Y, from the viewpoint that a difference in helical twisting power before and after a temperature change is large, an isosorbide optically active compound, an isomannide optically active compound, or a binaphthol optically active compound is preferable, and a binaphthol optically active compound is more preferable.

Chiral Agent YA

In a case where the chiral agent Y is used in combination with a chiral agent (hereinafter, also referred to as “chiral agent YA”) that induces the helix in the opposite direction, the chiral agent YA is a compound that induces the helix of the liquid crystal compound, and is preferably a chiral agent in which the helical twisting power (HTP) does not change due to a temperature change.

In addition, the chiral agent YA may be liquid crystalline or amorphous. In general, the chiral agent YA has an asymmetric carbon atom. However, an axially asymmetric compound or a planar asymmetric compound not having an asymmetric carbon atom can also be used as the chiral agent YA. The chiral agent YA may include a polymerizable group.

As the chiral agent YA, a well-known chiral agent can be used.

In a case where the liquid crystal composition includes one kind of the chiral agent Y and the helical twisting power of the chiral agent Y exceeds a predetermined range (for example, 0.0 to 1.9 μm⁻¹) at the above-described temperature T₁₁, it is preferable that the chiral agent YA is a chiral agent that induces the helix in the direction opposite to that of the above-described chiral agent Y. That is, for example, in a case where the helix induced by the chiral agent Y is the right direction, the helix induced by the chiral agent YA is the left direction.

In addition, in a case where the liquid crystal composition includes plural kinds of the chiral agents Y as the chiral agent and the weighted average helical twisting power of plural kinds of the chiral agents Y exceeds the above-described range at the above-described temperature T₁₁, it is preferable that the chiral agent YA is a chiral agent that induces the helix in a direction opposite to that of the weighted average helical twisting power.

The content of the chiral agent in the liquid crystal composition is preferably 0.01 to 200 mol % and more preferably 1 to 30 mol % with respect to the content molar amount of the liquid crystal compound.

—Polymerization Initiator—

In a case where the liquid crystal composition includes a polymerizable compound, it is preferable that the liquid crystal composition includes a polymerization initiator. In an aspect where a polymerization reaction progresses with ultraviolet irradiation, it is preferable that the polymerization initiator is a photopolymerization initiator which initiates a polymerization reaction with ultraviolet irradiation.

Examples of the photopolymerization initiator include an α-carbonyl compound (described in U.S. Pat. No. 2,367,661A and U.S. Pat. No. 2,367,670A), an acyloin ether (described in U.S. Pat. No. 2,448,828A), an α-hydrocarbon-substituted aromatic acyloin compound (described in U.S. Pat. No. 2,722,512A), a polynuclear quinone compound (described in U.S. Pat. No. 3,046,127A and U.S. Pat. No. 2,951,758A), a combination of a triarylimidazole dimer and p-aminophenyl ketone (described in U.S. Pat. No. 3,549,367A), an acridine compound and a phenazine compound (described in JP1985-105667A (JP-S60-105667A) and U.S. Pat. No. 4,239,850A), and an oxadiazole compound (described in U.S. Pat. No. 4,212,970A).

The content of the photopolymerization initiator in the liquid crystal composition is preferably 0.1 to 20 mass % and more preferably 0.5 to 12 mass % with respect to the content of the liquid crystal compound.

In addition from the viewpoints of the uniformity of the coating film and the hardness of the film, the liquid crystal composition may include a polymerizable monomer.

Examples of the polymerizable monomer include a radically polymerizable compound or a cationically polymerizable compound. The polymerizable monomer is preferably a polyfunctional radically polymerizable monomer and is preferably copolymerizable with the disk-shaped liquid crystal compound having the polymerizable group. For example, compounds described in paragraphs “0018” to “0020” in JP2002-296423A can be used.

The addition amount of the polymerizable monomer is preferably 1 to 50 parts by mass and more preferably 5 to 30 parts by mass with respect to 100 parts by mass of the liquid crystal compound.

—Crosslinking Agent—

In order to improve the film hardness after curing and to improve durability, the liquid crystal composition may optionally include a crosslinking agent. As the crosslinking agent, a curing agent which can perform curing with ultraviolet light, heat, moisture, or the like can be suitably used.

The crosslinking agent is not particularly limited and can be appropriately selected depending on the purpose. Examples of the crosslinking agent include: a polyfunctional acrylate compound such as trimethylol propane tri(meth)acrylate or pentaerythritol tri(meth)acrylate; an epoxy compound such as glycidyl (meth)acrylate or ethylene glycol diglycidyl ether; an aziridine compound such as 2,2-bis hydroxymethyl butanol-tris[3-(1-aziridinyl)propionate] or 4,4-bis(ethyleneiminocarbonylamino)diphenylmethane; an isocyanate compound such as hexamethylene diisocyanate or a biuret type isocyanate; a polyoxazoline compound having an oxazoline group at a side chain thereof; and an alkoxysilane compound such as vinyl trimethoxysilane or N-(2-aminoethyl)-3-aminopropyltrimethoxysilane. In addition, depending on the reactivity of the crosslinking agent, a well-known catalyst can be used, and not only film hardness and durability but also productivity can be improved. Among these crosslinking agents, one kind may be used alone, or two or more kinds may be used in combination.

The content of the crosslinking agent is preferably 3 to 20 mass % and more preferably 5 to 15 mass % with respect to the solid content mass of the liquid crystal composition. In a case where the content of the crosslinking agent is in the above-described range, an effect of improving a crosslinking density can be easily obtained, and the stability of a cholesteric liquid crystalline phase is further improved.

—Solvent—

In a case where the cholesteric liquid crystal layer 16 is formed, it is preferable that the liquid crystal composition is used as a liquid. Therefore, the liquid crystal composition may include a solvent and preferably an organic solvent.

Examples of the organic solvent include amides (for example, N,N-dimethylformamide), sulfoxides (for example, dimethyl sulfoxide), heterocyclic compounds (for example, pyridine), hydrocarbons (for example, benzene, or hexane), alkyl halides (for example, chloroform or dichloromethane), esters (for example, methyl acetate, ethyl acetate, or butyl acetate), ketones (for example, acetone or methyl ethyl ketone), and ethers (for example, tetrahydrofuran or 1,2-dimethoxyethane). Alkyl halide or ketone is preferable. Two or more organic solvents may be used in combination.

—Other Additives—

Optionally, an alignment control agent, a polymerization inhibitor, an antioxidant, an ultraviolet absorber, a light stabilizer, a coloring material, metal oxide particles, or the like can be added to the liquid crystal composition in a range where optical performance and the like do not deteriorate.

(Alignment Control Agent)

In a case where the liquid crystal composition is applied to the alignment film 14, the liquid crystal composition may include at least one additive (alignment control agent) for aligning the liquid crystal compound 40 on the air interface side in a state where it is tilted with respect to the surface of the cholesteric liquid crystal layer 16. By the composition including the alignment control agent, the liquid crystal compound 40 in the cholesteric liquid crystal layer 16 of the optical element can be tilted with respect to the surface of the cholesteric liquid crystal layer 16 in the entire region in the thickness direction.

The alignment control agent is a composition including: a fluoropolymer (X) having a constitutional unit represented by Formula (A) described below; and a fluoropolymer (Y) having a polar group without having the constitutional unit represented by Formula (A) described below.

In the present invention, as described above, by mixing the fluoropolymer (X) and the fluoropolymer (Y) as the alignment control agent, the tilt of the liquid crystal compound in the formed cholesteric liquid crystal layer can be controlled.

Although the details are not clear, it is presumed that, by inserting the rod-shaped liquid crystal compound between fluoropolymers (X) arranged at a regular interval, the tilt of the liquid crystal compound in the polymerized cholesteric liquid crystal layer can be controlled. In addition, it is presumed that the fluoropolymer (Y) holds the arrangement of the fluoropolymers (X) such that thickness unevenness of the formed cholesteric liquid crystal layer can be suppressed.

It is preferable that the alignment control agent includes at least: a fluoropolymer (X) having a constitutional unit represented by Formula (A) described below; and a fluoropolymer (Y) having a polar group without having the constitutional unit represented by Formula (A) described below.

<Fluoropolymer (X)>

The fluoropolymer (X) includes a constitutional unit represented by Formula (A) described below.

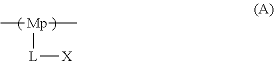

(In Formula (A), Mp represents a trivalent group forming a part of a polymer main chain, L represents a single bond or a divalent linking group, and X represents a substituted or unsubstituted fused ring functional group.)

In Formula (A), Mp represents a trivalent group forming a part of a polymer main chain.

Preferable examples of Mp include a substituted or unsubstituted long-chain or branched alkylene group having 2 to 20 carbon atoms (not including the number of carbon atoms in a substituent) (for example, an ethylene group, a propylene group, a methylethylene group, a butylene group, or a hexylene group), a substituted or unsubstituted cyclic alkylene group having 3 to 10 carbon atoms (for example, a cyclopropylene group, a cyclobutylene group, or a cyclohexylene group), a substituted or unsubstituted vinylene group, a substituted or unsubstituted cyclic vinylene group, a substituted or unsubstituted phenylene group, a group having an oxygen atom (for example, a group having an ether group, an acetal group, an ester group, a carbonate group, or the like), a group having a nitrogen atom (for example, group having an amino group, an imino group, an amide group, a urethane group, a ureido group, an imide group, an imidazole group, an oxazole group, a pyrrole group, an anilide group, a maleinimide group, or the like), a group having a sulfur atom (for example, a group having a sulfide group, a sulfone group, a thiophene group, or the like), a group having a phosphorus atom (for example, a group having a phosphine group, a phosphate group, or the like), a group having a silicon atom (for example, a group having a siloxane group), a group obtained by linking two or more of the above-described groups, and a group obtained by substituting one hydrogen atom in each of the above-described groups with a -L-X group.

Among these, a substituted or unsubstituted ethylene group, a substituted or unsubstituted methylethylene group, a substituted or unsubstituted cyclohexylene group, or a substituted or unsubstituted vinylene group where one hydrogen atom is substituted with a -L-X group is preferable, a substituted or unsubstituted ethylene group, a substituted or unsubstituted methylethylene group, or a substituted or unsubstituted vinylene group where one hydrogen atom is substituted with a -L-X group is more preferable, and a substituted or unsubstituted ethylene group or a substituted or unsubstituted methylethylene group where one hydrogen atom is substituted with a -L-X group is still more preferable. Specifically, Mp-1 or Mp-2 described below is preferable.

Hereinafter, specific preferable example of Mp will be shown, but Mp is not limited to these examples. In addition, a moiety represented by * in Mp represents a moiety linked to L.

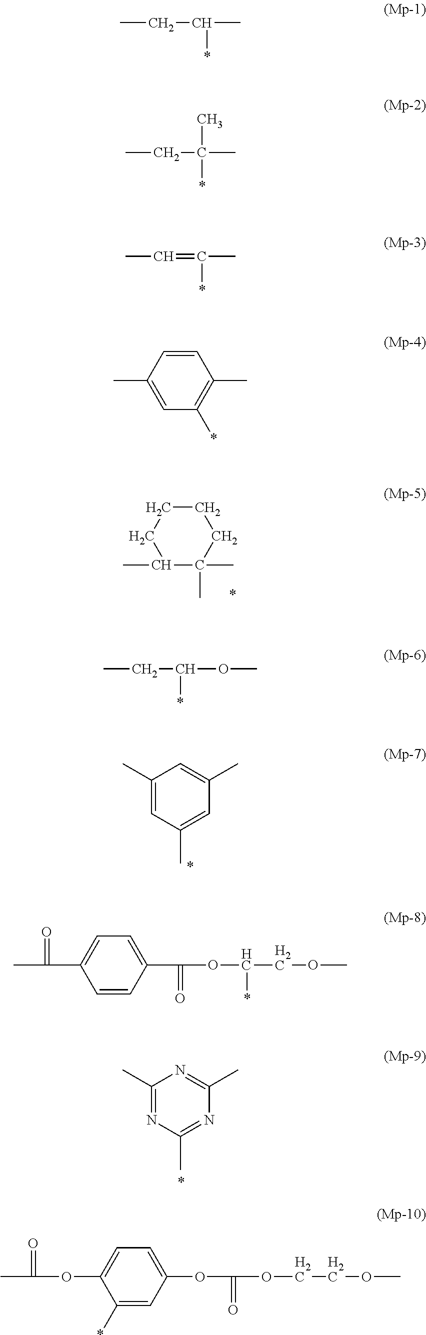

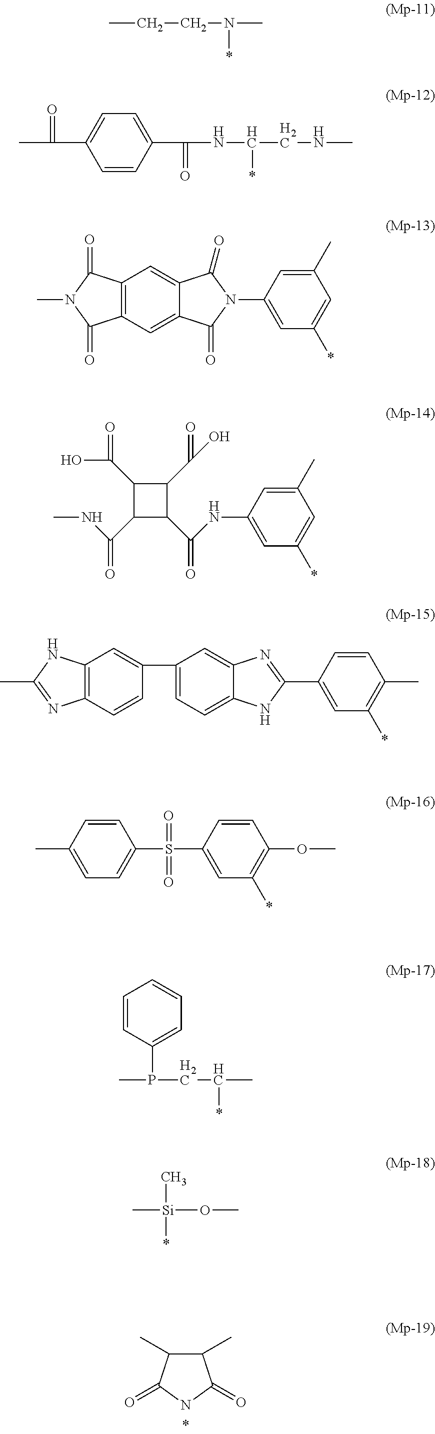

In a case where L (a single bond or a divalent linking group) in Formula (A) represents a divalent linking group, it is preferable that the divalent linking group is a divalent linking group represented by *-L1-L2- (* represents a linking site to a main chain) where L1 represents *—COO—, *—CONH—, *—OCO—, or *—NHCO— and L2 represents an alkylene group having 2 to 20 carbon atoms, a polyoxyalkylene group having 2 to 20 carbon atoms, or a divalent linking group including a combination thereof.

In particular, a linking group where L1 represents *—COO— and L2 represents a polyoxyalkylene group having 2 to 20 carbon atoms is preferable.

The number of rings in the substituted or unsubstituted fused ring functional group represented by X in Formula (A) is not limited and is preferably 2 to 5. The substituted or unsubstituted fused ring functional group may be a hydrocarbon aromatic fused ring consisting of only carbon atoms as atoms forming the ring, or may be an aromatic fused ring in which heterocycles including heteroatoms as ring-constituting atoms are fused.

In addition, for example, it is preferable that X represents a substituted or unsubstituted indenyl group having 5 to 30 carbon atoms, a substituted or unsubstituted naphthyl group having 6 to 30 carbon atoms, a substituted or unsubstituted fluorenyl group having 12 to 30 carbon atoms, an anthryl group, a pyrenyl group, a perylenyl group, or a phenanthrenyl group.

Among these, X represents preferably a substituted or unsubstituted indenyl group having 5 to 30 carbon atoms or a substituted or unsubstituted naphthyl group having 6 to 30 carbon atoms, more preferably a substituted or unsubstituted naphthyl group having 10 to 30 carbon atoms, and still more preferably a substituted or unsubstituted naphthyl group having 10 to 20 carbon atoms.

Hereinafter, preferable specific examples of the constitutional unit represented by Formula (A) will be shown, but the present invention is not limited thereto.

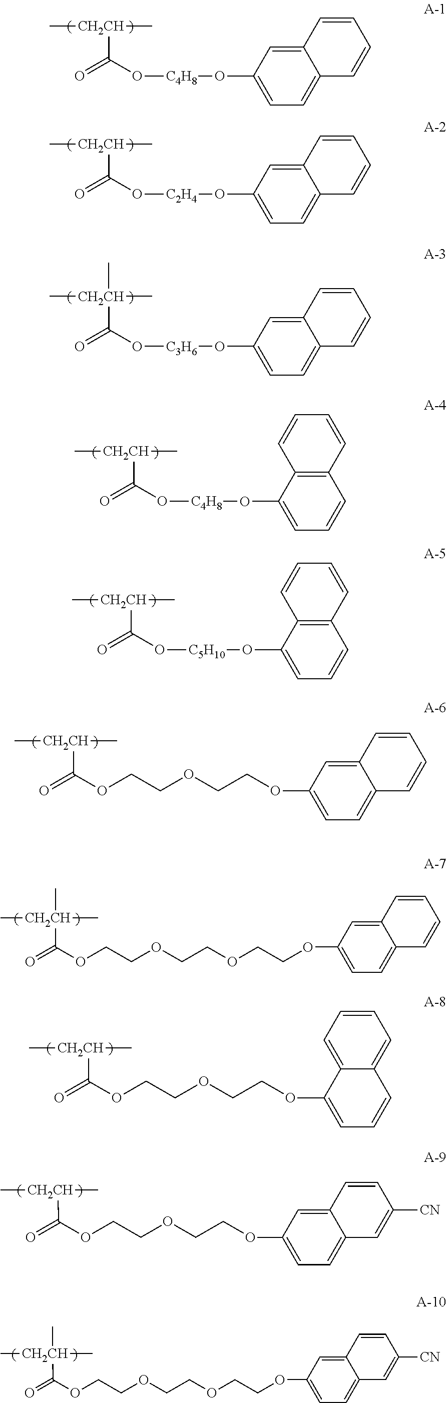

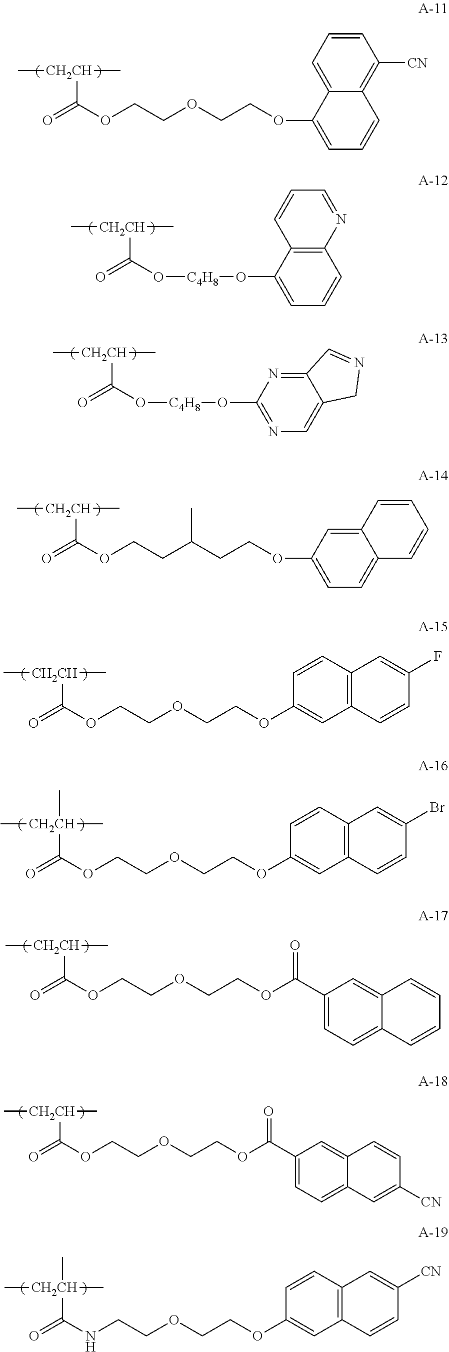

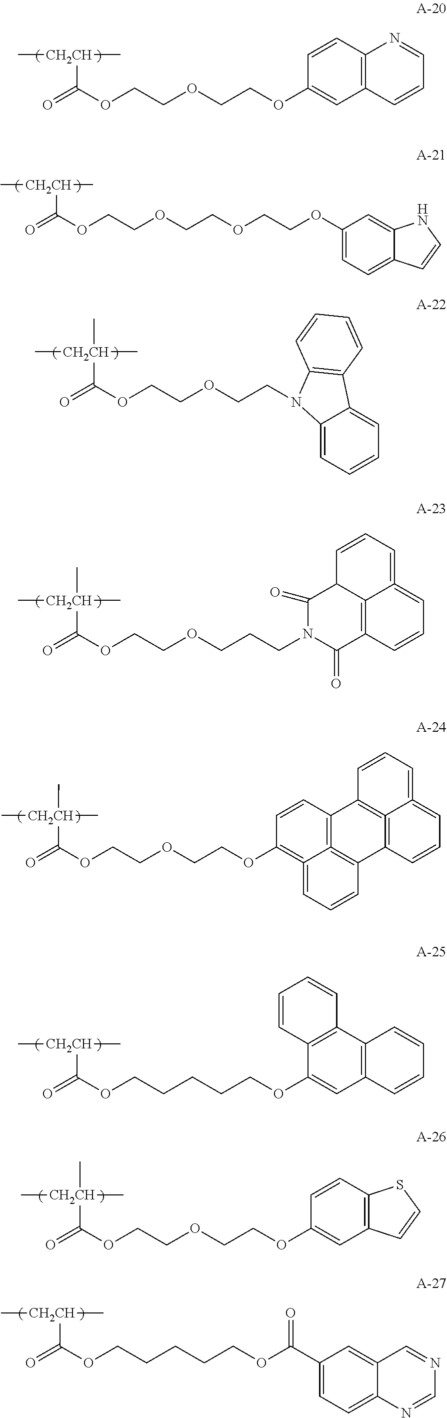

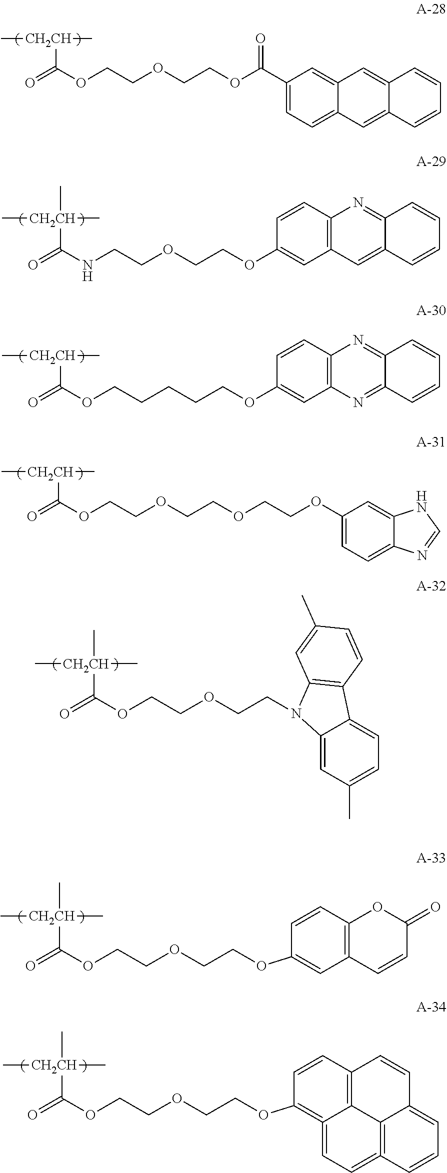

In addition, in addition to the constitutional unit represented by Formula (A), it is preferable that the fluoropolymer (X) includes, for example, a constitutional unit derived from a fluoroaliphatic group-containing monomer, and it is more preferable that the fluoropolymer (X) includes a constitutional unit represented by the following Formula (B).

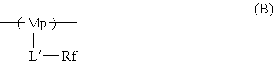

(In Formula (B), Mp represents a trivalent group forming a part of a polymer main chain, L′ represents a single bond or a divalent linking group, and Rf represents a substituent having at least one fluorine atom).

Mp in Formula (B) has the same definition and the same preferable range as Mp in Formula (A).

In a case where L′ (a single bond or a divalent linking group) represents a divalent linking group, the divalent linking group is preferably —O—, —NRa11- (where Ra11 represents a hydrogen atom, an aliphatic hydrocarbon group having 1 to 10 carbon atoms, or an aryl group having 6 to 20 carbon atoms), —S—, —C(═O)—, —S(═O)₂—, a substituted or unsubstituted alkylene group having 1 to 20 carbon atoms, or and a divalent linking group selected from groups formed by two or more of the above-described groups being linked to each other.

Examples of the divalent linking group formed by two or more of the above-described groups being linked to each other include —C(═O)O—, —OC(═O)—, —OC(═O)O—, —C(═O)NH—, —NHC(═O)—, and —C(═O)O(CH2)maO— (where ma represents an integer of 1 to 20).

Further, in a case where Mp in Formula (B) represents Mp-1 or Mp-2, L′ represents —O—, —NRa11- (Ra11 represents preferably a hydrogen atom or an aliphatic hydrocarbon group having 1 to 10 carbon atoms), —S—, —C(═O)—, —S(═O)₂—, a substituted or unsubstituted alkylene group having 1 to 20 carbon atoms, or a divalent linking group selected from groups formed by two or more of the above-described groups being linked to each other, and more preferably —O—, —C(═O)O—, —C(═O)NH—, or a divalent linking group consisting of one or more of the above-described groups and an alkylene group.

Preferable examples of Rf include an aliphatic hydrocarbon group having 1 to 30 carbon atoms in which at least one fluorine atom is substituted (for example, a trifluoroethyl group, a perfluorohexylethyl group, a perfluorohexylpropyl group, a perfluorobutylethyl group, or a perfluorooctylethyl group). In addition, it is preferable that Rf has a CF₃ group or a CF₂H group at a terminal, and it is more preferable Rf has a CF₃ group at a terminal.

It is more preferable that Rf represents an alkyl group having a CF₃ group at a terminal or an alkyl group having a CF₂H group at a terminal. The alkyl group having a CF₃ group at a terminal is an alkyl group in which a part or all of hydrogen atoms in the alkyl group are substituted with fluorine atoms. An alkyl group having a CF₃ group at a terminal in which 50% or higher of hydrogen atoms are substituted with fluorine atoms is preferable, an alkyl group having a CF₃ group at a terminal in which 60% or higher of hydrogen atoms are substituted with fluorine atoms is more preferable, and an alkyl group having a CF₃ group at a terminal in which 70% or higher of hydrogen atoms are substituted with fluorine atoms is still more preferable. The remaining hydrogen atoms may be further substituted with a substituent described below as an example of a substituent group D.

The alkyl group having a CF₂H group at a terminal is an alkyl group in which a part or all of hydrogen atoms in the alkyl group are substituted with fluorine atoms. An alkyl group having a CF₂H group at a terminal in which 50% or higher of hydrogen atoms are substituted with fluorine atoms is preferable, an alkyl group having a CF₂H group at a terminal in which 60% or higher of hydrogen atoms are substituted with fluorine atoms is more preferable, and an alkyl group having a CF₂H group at a terminal in which 70% or higher of hydrogen atoms are substituted with fluorine atoms is still more preferable. The remaining hydrogen atoms may be further substituted with a substituent described below as an example of a substituent group D.

Substituent Group D

The substituent group D includes an alkyl group (an alkyl group having preferably 1 to 20 carbon atoms (which are carbon atoms in the substituent; hereinafter, the same shall be applied to the substituent group D), more preferably 1 to 12 carbon atoms, and still more preferably 1 to 8 carbon atoms; for example, a methyl group, an ethyl group, an isopropyl group, a tert-butyl group, an n-octyl group, an n-decyl group, an n-hexadecyl group, a cyclopropyl group, a cyclopentyl group, or a cyclohexyl group), an alkenyl group (an alkenyl group having preferably 2 to 20 carbon atoms, more preferably 2 to 12 carbon atoms, and still more preferably 2 to 8 carbon atoms; for example, a vinyl group, a 2-butenyl group, or a 3-pentenyl group), an alkynyl group (an alkynyl group having preferably 2 to 20 carbon atoms, more preferably 2 to 12 carbon atoms, and still more preferably 2 to 8 carbon atoms; for example, a propargyl group or a 3-pentynyl group), a substituted or unsubstituted amino group (an amino group having preferably 0 to 20 carbon atoms, more preferably 0 to 10 carbon atoms, still more preferably 0 to 6 carbon atoms; for example, a unsubstituted amino group, a methylamino group, a dimethylamino group, or a diethylamino group),

an alkoxy group (an alkoxy group having preferably 1 to 20 carbon atoms, more preferably 1 to 12 carbon atoms, and still more preferably 1 to 8 carbon atoms; for example, a methoxy group, an ethoxy group, or a butoxy group), an acyl group (an acyl group having preferably 1 to 20 carbon atoms, more preferably 1 to 16 carbon atoms, and still more preferably 1 to 12 carbon atoms; for example, an acetyl group, a formyl group, or a pivaloyl group), an alkoxycarbonyl groups (an alkoxycarbonyl group having preferably 2 to 20 carbon atoms, more preferably 2 to 16 carbon atoms, and still more preferably 2 to 12 carbon atoms; for example, a methoxycarbonyl group or an ethoxycarbonyl group), an acyloxy group (an acyloxy group having preferably 2 to 20 carbon atoms, more preferably 2 to 16 carbon atoms, and still more preferably 2 to 10 carbon atoms; for example, an acetoxy group),

an acylamino group (an acylamino group having preferably 2 to 20 carbon atoms, more preferably 2 to 16 carbon atoms, and still more preferably 2 to 10 carbon atoms; for example, an acetylamino group), an alkoxycarbonylamino group (an alkoxycarbonylamino group having preferably 2 to 20 carbon atoms, more preferably 2 to 16 carbon atoms, and still more preferably 2 to 12 carbon atoms; for example, a methoxycarbonylamino group), a sulfonylamino group (a sulfonylamino group having preferably 1 to 20 carbon atoms, more preferably 1 to 16 carbon atoms, and still more preferably 1 to 12 carbon atoms; for example, a methanesulfonylamino group or an ethanesulfonylamino group), a sulfamoyl group (a sulfamoyl group having preferably 0 to 20 carbon atoms, more preferably 0 to 16 carbon atoms, and still more preferably 0 to 12 carbon atoms; for example, a sulfamoyl group, a methylsulfamoyl group, or a dimethylsulfamoyl group),

an alkylthio group (an alkylthio group having preferably 1 to 20 carbon atoms, more preferably from 1 to 16 carbon atoms, and still more preferably from 1 to 12 carbon atoms; for example, a methylthio group or an ethylthio group), a sulfonyl group (a sulfonyl group having preferably 1 to 20 carbon atoms, more preferably from 1 to 16 carbon atoms, and still more preferably from 1 to 12 carbon atoms; for example, a mesyl group or a tosyl group), a sulfinyl group (a sulfinyl group having preferably 1 to 20 carbon atoms, more preferably from 1 to 16 carbon atoms, and still more preferably from 1 to 12 carbon atoms; for example, a methanesulfinyl group or an ethanesulfinyl group), a ureido group (a ureido group having preferably 1 to 20 carbon atoms, more preferably 1 to 16 carbon atoms, and still more preferably 1 to 12 carbon atoms; for example, an unsubstituted ureido group or a methylureido group), a phosphoric amide group (a phosphoric amide group having preferably 1 to 20 carbon atoms, more preferably 1 to 16 carbon atoms, and still more preferably 1 to 12 carbon atoms; for example, a diethylphosphoric amide group), a hydroxyl group, a mercapto group, a halogen atom (for example, a fluorine atom, a chlorine atom, a bromine atom, or an iodine atom), a cyano group, a sulfo group, a carboxyl group, a nitro group, a hydroxamic acid group, a sulfino group, a hydrazino group, an imino group, and a silyl group (a silyl group having preferably from 3 to 40 carbon atoms, more preferably from 3 to 30 carbon atoms, and still more preferably from 3 to 24 carbon atoms; for example, a trimethylsilyl group). The substituents may be further substituted with the substituents. In addition, in a case where two or more substituents are present, the substituents may be the same as or different from each other. In addition, if possible, the substituents may be bonded to each other to form a ring.

Examples of the alkyl group having a CF₃ group at a terminal or the alkyl group having a CF₂H group at a terminal are as follows.

R1: n-C₈F₁₇—

R2: n-C₆F₁₃—

R3: n-C₄F₉—

R4: n-C₈F₁₇—(CH₂)₂—

R5: n-C₆F₁₃—(CH₂)₃—

R6: n-C₄F₉—(CH₂)₂—

R7: H—(CF₂)₈—

R8: H—(CF₂)₆—

R9: H—(CF₂)₄—

R10: H—(CF₂)₈—(CH₂)₂—

R11: H—(CF₂)₆—(CH₂)₃—

R12: H—(CF₂)₄—(CH₂)₂—

R13: n-C₇F₁₅—(CH₂)₂—

R14: n-C₆F₁₃—(CH₂)₃—

R15: n-C₄F₉—(CH₂)₂—

Hereinafter, specific examples of the constitutional unit derived from the fluoroaliphatic group-containing monomer will be shown, but the present invention is not limited thereto.

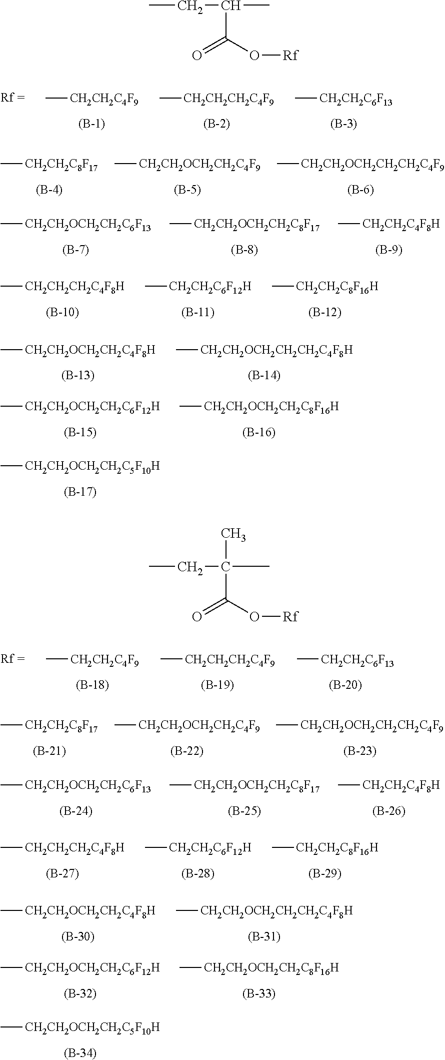

In addition, in addition to the constitutional unit having the structure represented by Formula (A) and the constitutional unit derived from the fluoroaliphatic group-containing monomer that is represented by Formula (B), the fluoropolymer (X) used in the present invention may include a constitutional unit derived from a monomer that is copolymerizable with the monomer forming the constitutional unit.

The copolymerizable monomer is not particularly limited within a range not departing from the scope of the present invention. As the preferable monomer, for example, from the viewpoint of improving solubility in a solvent or preventing aggregation of a polymer, a monomer forming a hydrocarbon polymer (for example, polyethylene, polypropylene, polystyrene, polymaleimide, polyacrylic acid, polyacrylic acid ester, polyacrylamide, or polyacryl anilide), polyether, polyester, polycarbonate, polyamide, polyamic acid, polyimide, polyurethane, or polyureide can be preferably used.

Further, as the main chain structure, a constitutional unit that is the same as the unit having the group represented by Formula (A) is preferable.

Hereinafter, specific examples of the copolymerizable constitutional unit will be shown, but the present invention is not limited to the following specific examples. In particular, C-2, C-3, C-10, C-11, C-12, or C-19 is preferable, and C-11 or C-19 is more preferable.

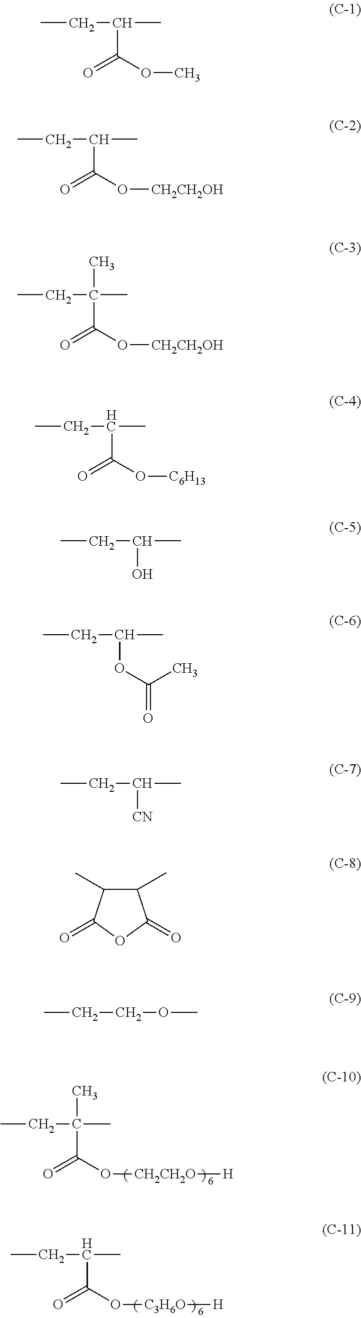

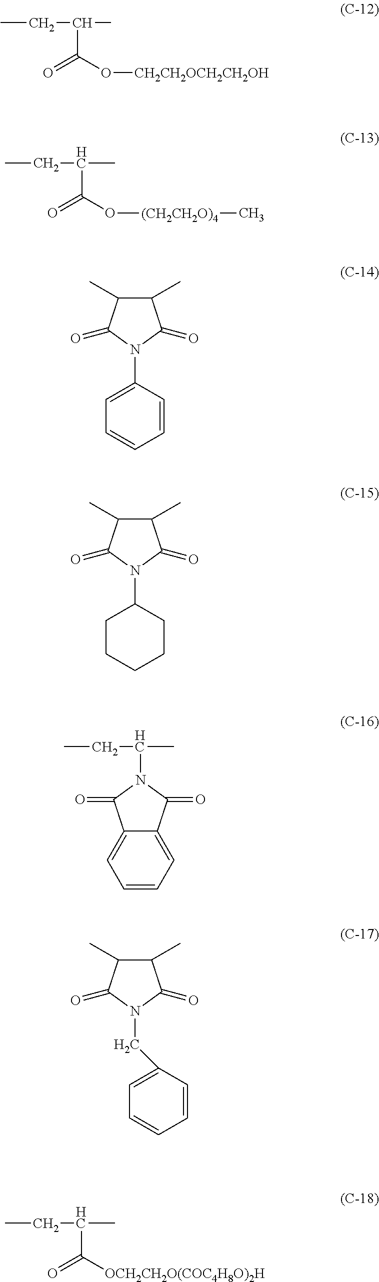

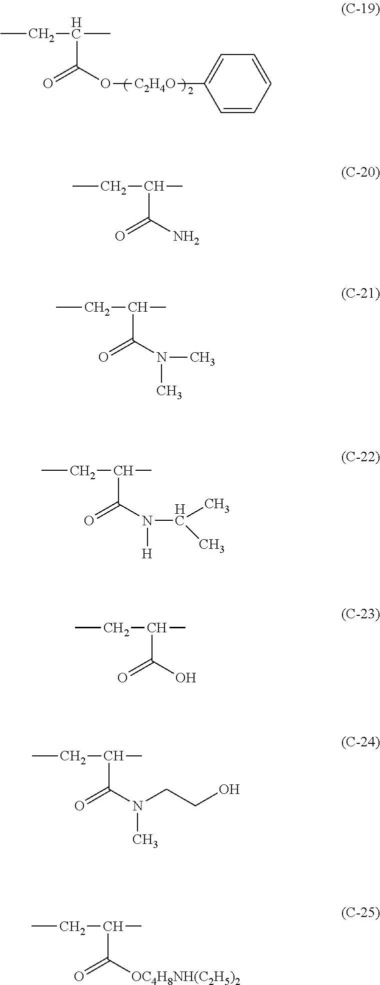

In the fluoropolymer (X), the content of the constitutional unit represented by Formula (A) is preferably 1 to 90 mass % and more preferably 3 to 80 mass %.

In addition, in the fluoropolymer (X), the content of the repeating unit derived from the fluoroaliphatic group-containing monomer (preferably the constitutional unit represented by Formula (B)) is preferably 5 to 90 mass % and more preferably 10 to 80 mass %.

The content of a constitutional unit other than the above-described two constitutional units is preferably 60 mass % or lower and more preferably 50 mass % or lower.

In addition, the fluoropolymer (X) may be a random copolymer into which the respective constitutional units are irregularly introduced or may be a block copolymer into which the respective constitutional units are regularly introduced. In a case where the fluoropolymer (X) is the block copolymer, the block copolymer may be synthesized by introducing the respective constitutional units in any introduction order or by using the same component twice or more.

In addition, as the constitutional unit represented by Formula (A), the constitutional unit represented by Formula (B), or the like, only one kind may be used, or two or more kinds may be used. In a case where two or more constitutional units represented by Formula (A) are included, it is preferable that X represents the same fused ring skeleton (a combination of a substituted group and an unsubstituted group). In a case where two or more constitutional units are included, the content refers to a total content.

Further, the range of the number-average molecular weight (Mn) of the fluoropolymer (X) is preferably 1000 to 1000000, more preferably 3000 to 200000, and still more preferably 5000 to 100000. In addition, a molecular weight distribution (Mw/Mn; Mw represents a weight-average molecular weight) of the polymer used in the present invention is preferably 1 to 4 and more preferably 1.5 to 4.

Here, the number-average molecular weight can be measured as a value in terms of polystyrene (PS) obtained by gel permeation chromatography (GPC).

<Fluoropolymer (Y)>

The fluoropolymer (Y) includes a polar group without including the constitutional unit represented by Formula (A).

Here, the polar group refers to a group having at least one heteroatom or at least one halogen atom, and specific examples thereof include a hydroxyl group, a carbonyl group, a carboxy group, an amino group, a nitro group, an ammonium group, and a cyano group. Among these, a hydroxyl group or a carboxy group is preferable.

In the present invention, it is preferable that the fluoropolymer (Y) includes a constitutional unit represented by the following Formula (C).

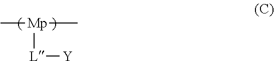

(In Formula (C), Mp represents a trivalent group forming a part of a polymer main chain, L represents a single bond or a divalent linking group, and Y represents a polar group.)

Mp in Formula (C) has the same definition and the same preferable range as Mp in Formula (A). In a case where L″ (a single bond or a divalent linking group) in Formula (A) represents a divalent linking group, it is preferable that the divalent linking group is a divalent linking group represented by *-L1-L3- (* represents a linking site to a main chain) where L1 represents *—COO—, *—CONH—, *—OCO—, or *—NHCO— and L3 represents an alkylene group having 2 to 20 carbon atoms, a polyoxyalkylene group having 2 to 20 carbon atoms, —C(═O)—, —OC(═O)O—, an aryl group, or a divalent linking group including a combination thereof.

Among these, it is preferable that L″ represents a single bond; a divalent linking group where L1 represents *—COO and L3 represents a divalent linking group including a combination of an alkylene group, —OC(═O)O—, and an aryl group; or a divalent linking group where L1 represents *—COO— and L3 represents a polyoxyalkylene group having 2 to 20 carbon atoms.

In addition, examples of the polar group represented by Y in Formula (C) include a hydroxyl group, a carbonyl group, a carboxy group, an amino group, a nitro group, an ammonium group, and a cyano group. Among these, a hydroxyl group, a carboxy group, or a cyano group is preferable.

In addition, as in the fluoropolymer (X), in addition to the constitutional unit represented by Formula (C), it is preferable that the fluoropolymer (Y) includes, for example, a constitutional unit derived from a fluoroaliphatic group-containing monomer, and it is more preferable that the fluoropolymer (Y) includes a constitutional unit represented by Formula (B).

Likewise, as in the fluoropolymer (X), in addition to the constitutional unit having the structure represented by Formula (C) and the constitutional unit derived from the fluoroaliphatic group-containing monomer that is represented by Formula (B), the fluoropolymer (Y) may include a constitutional unit derived from a monomer that is copolymerizable with the monomer forming the constitutional unit.

In the fluoropolymer (Y), the content of the constitutional unit represented by Formula (C) is preferably 45 mass % or lower, more preferably 1 to 20 mass %, and still more preferably 2 to 10 mass %.

In addition, in the fluoropolymer (Y), the content of the repeating unit derived from the fluoroaliphatic group-containing monomer (preferably the constitutional unit represented by Formula (B)) is preferably 55 mass % or higher, more preferably 80 to 99 mass % and more preferably 90 to 98 mass %. The content of a constitutional unit other than the above-described two constitutional units is preferably 60 mass % or lower and more preferably 50 mass % or lower.

In addition, the fluoropolymer (Y) may be a random copolymer into which the respective constitutional units are irregularly introduced or may be a block copolymer into which the respective constitutional units are regularly introduced. In a case where the fluoropolymer (Y) is the block copolymer, the block copolymer may be synthesized by introducing the respective constitutional units in any introduction order or by using the same component twice or more.

In addition, as the constitutional unit represented by Formula (C), the constitutional unit represented by Formula (B), or the like, only one kind may be used, or two or more kinds may be used. In a case where two or more constitutional units represented by Formula (C) are included, it is preferable that Y represents the same polar group. In a case where two or more constitutional units are included, the content refers to a total content.

Further, the range of the weight-average molecular weight (Mw) of the fluoropolymer (Y) is preferably 10000 to 35000 and more preferably 15000 to 30000.

Here, the weight-average molecular weight can be measured as a value in terms of polystyrene (PS) obtained by gel permeation chromatography (GPC).

(Mass Ratio Between Fluoropolymer (X) and Fluoropolymer (Y) (A:B))

The mass ratio is preferably 98:2 to 2:98, more preferably 98:2 to 55:45, and still more preferably 98:2 to 60:40.

In the present invention, the content of the air interface alignment agent including the fluoropolymer (X) and the fluoropolymer (Y) is preferably 0.2 to 10 mass %, more preferably 0.2 to 5 mass %, and still more preferably 0.2 to 3 mass % with respect to the total solid content of the liquid crystal composition.

<Heating Step>

The heating step is a step of heating the applied liquid crystal composition to align the liquid crystal compound.

Due to the heating treatment, the liquid crystal compound 40 in the liquid crystal composition layer is in the cholesterically aligned state where it is helically twisted in the thickness direction, and the liquid crystal compound 40 on the alignment film 14 side surface is aligned in a direction parallel to or perpendicular to the direction of the alignment treatment depending on the direction of the alignment treatment that is performed on the alignment film 14.

It is preferable that the composition layer is heated under heating conditions of 40° C. to 150° C. (preferably 60° C. to 100° C.) for 0.5 to 5 minutes (preferably 0.5 to 2 minutes). In a case where the composition layer is heated, it is preferable that the composition layer is not heated up to a temperature at which the liquid crystal compound is in an isotropic phase (Iso). In a case where the composition layer is heated up to the temperature at which the liquid crystal compound is in an isotropic phase, defects of the aligned liquid crystal phase increase, which is not preferable.

<Curing Step>

The curing step is a step of curing the liquid crystal composition to immobilize the alignment of the cholesteric liquid crystal layer 16. The second application step, the heating step, and the curing step correspond to the liquid crystal layer forming step in the present invention.

A curing method is not particularly limited, and examples thereof include a photocuring treatment and a thermal curing treatment. In particular, a light irradiation treatment is preferable, and an ultraviolet irradiation treatment is more preferable. In a case where the liquid crystal compound has a polymerizable group, it is preferable that the curing treatment is a polymerization reaction by light irradiation (in particular, ultraviolet irradiation), and it is more preferable that the curing treatment is a radical polymerization reaction by light irradiation (in particular, ultraviolet irradiation).

For the ultraviolet irradiation, a light source such as an ultraviolet lamp is used.

The irradiation energy dose of ultraviolet light is not particularly limited and, in general, is preferably about 100 to 800 mJ/cm². The time of ultraviolet irradiation is not particularly limited and may be appropriately determined from the viewpoint of obtaining both sufficient strength and productivity of the obtained layer.

A method of forming the cholesteric liquid crystal layer 16 is not limited to the above-described methods, and various well-known forming methods can be used. In particular, in the above-described method of forming the cholesteric liquid crystal layer, the cholesteric liquid crystal layer 16 according to the embodiment of the present invention can be stably and suitably formed, which is preferable.

The cholesteric liquid crystal layer 16 that is formed as described above may be a structure in which the alignment of the liquid crystal compound as a cholesteric liquid crystalline phase is immobilized. It is preferable that a layer that has no fluidity is formed by curing and is changed into a state where the alignment state does not change due to an external field or an external force.

The structure in which a cholesteric liquid crystalline phase is immobilized is not particularly limited as long as the optical characteristics of the cholesteric liquid crystalline phase are maintained, and the liquid crystal compound 40 in the cholesteric liquid crystal layer does not necessarily exhibit liquid crystallinity. For example, the molecular weight of the polymerizable liquid crystal compound may be increased by a curing reaction such that the liquid crystallinity thereof is lost.

Through the above-described steps, the optical element 10 shown FIG. 6 is prepared, the optical element 10 including: the support 12; the alignment film 14 having the periodic unevenness shape having the tilted surface that is tilted with respect to the support 12; and the cholesteric liquid crystal layer 16 that is formed on the alignment film 14.

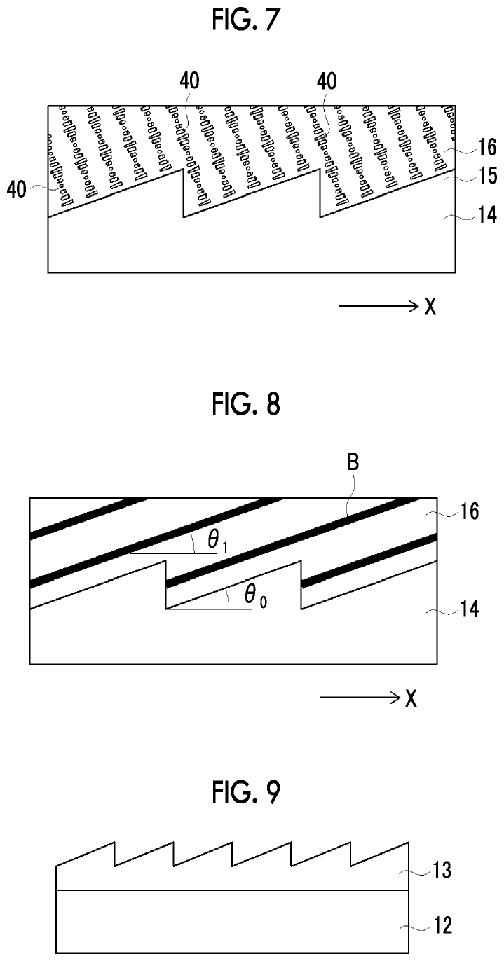

FIG. 7 is an enlarged view showing the cholesteric liquid crystal layer 16 and the alignment film 14 of the optical element 10 that is manufactured using the manufacturing method according to the embodiment of the present invention. In the following description, it is assumed that the liquid crystal compound 40 is a rod-shaped liquid crystal compound in FIG. 7.

As shown in FIG. 7, the liquid crystal compound 40 on the alignment film 14 side is aligned in one in-plane direction depending on the alignment treatment that is performed on the alignment film 14. In the example shown in FIG. 7, the liquid crystal compound 40 on the alignment film 14 side is aligned such that a major axis direction thereof is parallel to a periodic direction of the unevenness shape.

In addition, the liquid crystal compound 40 on the alignment film 14 side is aligned to be parallel to the tilted surface of the protrusion portion 15 of the alignment film 14. Therefore, the major axis direction of the liquid crystal compound 40 is tilted with respect to the main surface of the cholesteric liquid crystal layer 16 (the main surface opposite to the alignment film 14).

In addition, as shown in FIG. 7, a plurality of the liquid crystal compounds 40 are arranged on one tilted surface. Therefore, regarding the liquid crystal compounds 40 on the alignment film 14 side in the cholesteric liquid crystal layer 16, the liquid crystal compounds 40 having different positions in the thickness direction are arranged such that the major axis directions thereof face the same direction.

Further, as shown in FIG. 7, the liquid crystal compounds 40 in the cholesteric liquid crystal layer 16 are aligned to have a helical structure (cholesteric liquid crystalline phase) in which the liquid crystal compounds 40 are helically turned and laminated in order from the liquid crystal compounds 40 on the alignment film 14 side in a direction perpendicular to the major axis direction of the liquid crystal compound 40. In this case, the liquid crystal compounds 40 on the alignment film 14 side are tilted with respect to the surface of the cholesteric liquid crystal layer 16. Therefore, the helical axis of the helical structure of the cholesteric liquid crystalline phase is tilted with respect to the thickness direction of the cholesteric liquid crystal layer 16. In addition, the liquid crystal compounds 40 other than the liquid crystal compound 40 on the alignment film 14 side are also tilted with respect to the surface of the cholesteric liquid crystal layer 16.

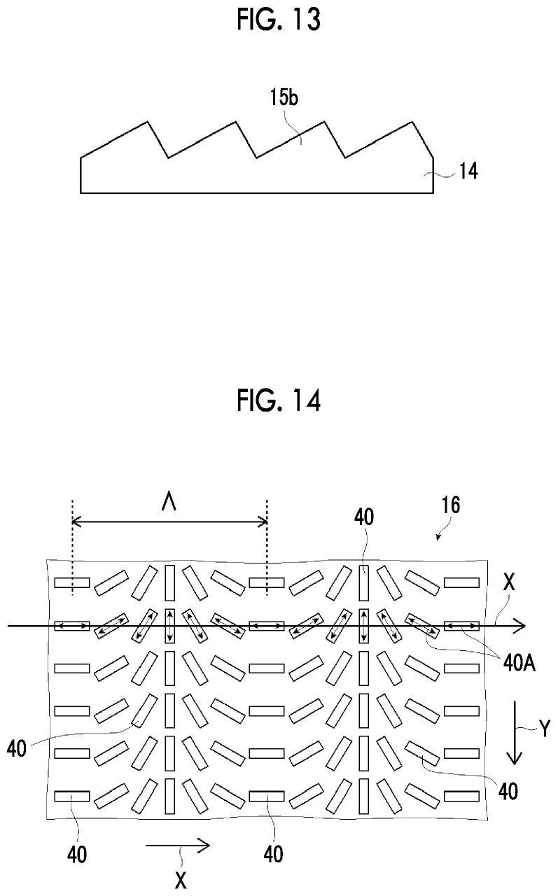

In addition, a plurality of the liquid crystal compounds 40 are arranged on one tilted surface, and the liquid crystal compounds 40 are aligned to the helical structure (cholesteric liquid crystalline phase) in order from the liquid crystal compound 40 on the alignment film 14 side having different positions in the thickness direction. Therefore, on the surface of the cholesteric liquid crystal layer 16 opposite to the alignment film 14, the directions of the major axis directions of the liquid crystal compounds 40 are different from each other (FIG. 14). This point will be described below.

FIG. 7 shows the example in which the liquid crystal compound 40 in the cholesteric liquid crystal layer 16 is aligned to be parallel to the tilted surface of the protrusion portion 15 of the alignment film 14. However, the liquid crystal compound 40 in the cholesteric liquid crystal layer 16 may be aligned at an angle that is not parallel to the tilted surface. In addition, the tilt angle of the liquid crystal compound 40 may vary in the thickness direction.

Here, in a cross-section of the cholesteric liquid crystal layer 16 observed with a SEM, a stripe pattern including bright portions (bright lines) and dark portions (dark lines) derived from the cholesteric liquid crystalline phase is observed as shown in FIG. 8.

The bright portions and the dark portions of the cholesteric liquid crystalline phase are formed to connect the liquid crystal compounds 40 that are helically turned and in which the directions of the optical axes (major axis directions) match with each other in the turning direction. Therefore, as shown in FIG. 8, in the cholesteric liquid crystal layer 16, the bright portions and the dark portions derived from the cholesteric liquid crystalline phase that are observed in the cross-sectional SEM image are tilted with respect to a main surface of the cholesteric liquid crystal layer 16 opposite to the alignment film 14.

Here, in the cholesteric liquid crystal layer, the surface of the bright portions and the dark portions is parallel to the reflecting surface where light is reflected. Therefore, in the cholesteric liquid crystal layer 16 of the optical element according to the embodiment of the present invention, the bright portions and the dark portions derived from the cholesteric liquid crystalline phase are tilted with respect to the main surface of the cholesteric liquid crystal layer 16 opposite to the alignment film 14. Therefore, light incident into the cholesteric liquid crystal layer 16 is reflected from the reflecting surface as the surface that is tilted with respect to the main surface. For example, light incident from the direction perpendicular to the main surface of the cholesteric liquid crystal layer 16 is reflected in a direction that is tilted in the tilt direction of the bright portions and the dark portions. As a result, the optical element 10 according to the embodiment of the present invention can diffract the incident light.

As described above, regarding the alignment film that aligns the liquid crystal compound in the cholesteric liquid crystal layer of the liquid crystal diffraction element diffracting light, in a case where the predetermined alignment pattern is formed on the alignment film using the method such as the photoalignment method or the rubbing method, it is necessary to change the alignment direction depending on fine regions, the steps become complicated, and there is a problem in that the manufacturing efficiency is poor. In addition, in these methods, there is a problem in that it is difficult to accurately form the alignment direction that varies depending on fine regions.

In addition, by periodically changing the interference state of the interference light obtained by interference between two polarized light components, the polarization state of light with which the alignment film is irradiated can periodically change according to interference fringes. As a result, the alignment pattern where the alignment state periodically changes can be formed on the alignment film. Regarding this method, it was found that, in a case where the size of an optical element increases, it is necessary to increase the beam diameter of the interference light, but the amount of light per unit area is weakened as the beam diameter increases. Therefore, the exposure time increases, the alignment restriction force of the formed alignment film is not sufficient, and there is a problem in that it is difficult to align the liquid crystal compound in the liquid crystal layer formed on the alignment film.

On the other hand, in the method of manufacturing an optical element according to the embodiment of the present invention, the alignment film having the periodic unevenness shape having the tilted surface that is tilted with respect to the support, and the cholesteric liquid crystal layer is formed on the alignment film having the unevenness shape. As described above, by forming the periodic unevenness shape having the tilted surface on the alignment film and forming the cholesteric liquid crystal layer on the alignment film having the unevenness shape, the liquid crystal compound is aligned along the unevenness shape (tilted surface). As a result, the cholesteric liquid crystal layer 16 in which bright portions and dark portions derived from the cholesteric liquid crystalline phase can be tilted with respect to the main surface of the cholesteric liquid crystal layer 16 opposite to the alignment film 14 can be formed.

In the manufacturing method according to the embodiment of the present invention, the unevenness shape can be imparted to the alignment film by transfer. Therefore, the manufacturing is easy, the manufacturing efficiency is high, and an increase in manufacturing time caused by an increase in size can be suppressed. In addition, a plurality of liquid crystal compounds are arranged on one tilted surface of the unevenness shape. Therefore, it is not necessary to change the alignment direction for each fine region, and the liquid crystal compounds can be suitably aligned without forming a fine alignment pattern. Therefore, the liquid crystal compounds in the cholesteric liquid crystal layer can be appropriately aligned with high accuracy.

The thickness of the cholesteric liquid crystal layer 16 formed using the manufacturing method according to the embodiment of the present invention is not particularly limited and may be appropriately set depending on the selective reflection center wavelength of the cholesteric liquid crystal layer 16, the reflectivity (diffraction efficiency) required for the cholesteric liquid crystal layer 16, and the like.

The thickness of the cholesteric liquid crystal layer 16 formed using the manufacturing method according to the embodiment of the present invention is preferably 0.5 μm or more and more preferably 1.0 μm or more. The upper limit of the thickness of the cholesteric liquid crystal layer 16 formed using the manufacturing method according to the embodiment of the present invention is about 6 μm.

Here, in the example shown in FIGS. 1 to 5, in the alignment film forming step, after applying an alignment material forming the alignment film to the support, the unevenness shape is transferred to the alignment material to form the alignment film having the unevenness shape. However, the present invention is not limited to this example.

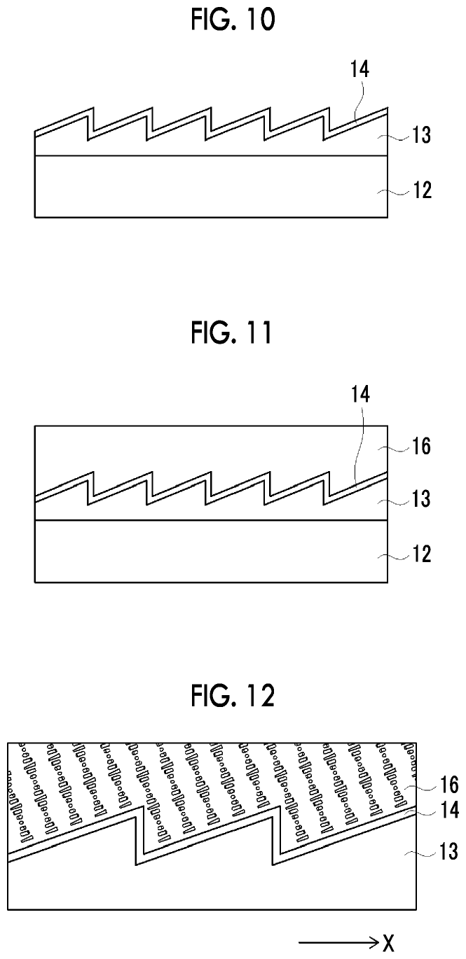

Another example of the alignment film forming step will be described using FIGS. 9 and 10.

The alignment film forming step shown in FIGS. 9 and 10 includes: a resin layer forming step of forming a resin layer having the unevenness shape on the support; and a film forming step of forming the alignment film on the resin layer having the unevenness shape.

<Resin Layer Forming Step>

The resin layer forming step is a step of applying a coating solution forming a resin layer to the surface of the support 12, pressing the coating solution layer against a transfer mold having the unevenness shape, and curing the resin layer to form a resin layer 13 having the unevenness shape (refer to FIG. 9).

For the application of the coating solution forming the resin layer, a printing method such as ink jet or scroll printing or a well-known method such as spin coating, bar coating, or spray coating capable of uniformly applying liquid to a sheet-shaped material can be used.

In addition, the transfer mold that transfers the unevenness shape to the resin layer 13 may have the same shape as the above-described transfer mold 100.

In addition, by releasing the transfer mold after curing the resin layer 13 by heating or the like in a state where the transfer mold is pressed, the resin layer 13 to which the unevenness shape is transferred may be formed.

As long as the unevenness shape can be formed, the material for forming the resin layer 13 may be appropriately selected in consideration of the use of the optical element 10, optical characteristics, flexibility, or rigidity required for the optical element 10, adhesiveness between the support 12 and the alignment film 14, and the like.

Specifically, a resin used for imprint or nanoimprint is preferable, and an acrylic resin, an epoxy resin, a urethane resin, or the like can be used.

<Film Forming Step>

The film forming step is a step of forming the alignment film 14 on the resin layer 13 having the unevenness shape as shown in FIG. 10.

As the alignment film 14, various well-known films can be used.

For example, the alignment film 14 may be the rubbed film formed of an organic compound such as a polymer a photo-alignment film formed of a photo-alignment material. Other examples of the alignment film 14 include an obliquely deposited film formed of an inorganic compound, a film having a microgroove, and a film formed by lamination of Langmuir-Blodgett (LB) films formed with a Langmuir-Blodgett's method using an organic compound such as ω-tricosanoic acid, dioctadecylmethylammonium chloride, or methyl stearate.

The alignment film 14 may be formed depending on the kind of the alignment film. For example, the alignment film 14 is the rubbed film formed of an organic compound such as a polymer, the alignment film 14 can be formed by applying the coating solution forming the alignment film 14 to the resin layer 13 and rubbing a surface of the polymer layer forming the alignment film 14 with paper or fabric in a given direction multiple times. A direction of the rubbing treatment is not particularly limited and may be a periodic direction of the unevenness shape formed in the alignment film 14, may be a direction (the width direction of the protrusion portion) perpendicular to the periodic direction, or may be a direction at a predetermined angle with respect to the periodic direction of the unevenness shape.

In addition, for example, in a case where the alignment film 14 is the photo-alignment film, after applying the coating solution forming the alignment film 14 to the resin layer 13, the alignment film 14 may be irradiated with polarized light or non-polarized light. The irradiation of polarized light can be performed in a direction perpendicular or oblique to the alignment film 14, and the irradiation of non-polarized light can be performed in a direction oblique to the alignment film. In addition, a direction of the alignment by light irradiation is not particularly limited and may be a periodic direction of the unevenness shape formed in the alignment film 14, may be a direction (the width direction of the protrusion portion) perpendicular to the periodic direction, or may be a direction at a predetermined angle with respect to the periodic direction of the unevenness shape.

As described above, even in a case where the alignment film 14 is formed on the resin layer 13 having the unevenness shape, the alignment film 14 having the unevenness shape shown in FIG. 10 can be formed.

After forming the alignment film 14, the cholesteric liquid crystal layer 16 is formed on the alignment film 14 having the unevenness shape. A method of forming the cholesteric liquid crystal layer 16 (liquid crystal layer forming step) is the same as the above-described liquid crystal layer forming step.

As a result, an optical element shown in FIG. 11 is manufactured, the optical element including: the support 12; the resin layer 13 having the periodic unevenness shape having the tilted surface that is tilted with respect to the support 12; and the alignment film 14 having the periodic unevenness shape having the tilted surface that is tilted with respect to the support 12; and the cholesteric liquid crystal layer 16 that is formed on the alignment film 14.

FIG. 12 is an enlarged view showing the cholesteric liquid crystal layer 16, the alignment film 14, and the resin layer 13 of the optical element 10 shown in FIG. 11.

The cholesteric liquid crystal layer 16 shown in FIG. 12 has the same configuration as that of the cholesteric liquid crystal layer 16 shown in FIG. 7.

That is, in the cholesteric liquid crystal layer 16 shown in FIG. 12, the liquid crystal compound 40 on the alignment film 14 side is aligned in one in-plane direction depending on the alignment treatment that is performed on the alignment film 14. In the example shown in FIG. 12, the liquid crystal compound 40 on the alignment film 14 side is aligned such that a major axis direction thereof is parallel to a periodic direction of the unevenness shape.

In addition, the liquid crystal compound 40 on the alignment film 14 side is aligned to be parallel to the tilted surface of the alignment film 14. Therefore, the major axis direction of the liquid crystal compound 40 is tilted with respect to the main surface of the cholesteric liquid crystal layer 16 (the main surface opposite to the alignment film 14).

In addition, as shown in FIG. 12, a plurality of the liquid crystal compounds 40 are arranged on one tilted surface. Therefore, regarding the liquid crystal compounds 40 on the alignment film 14 side in the cholesteric liquid crystal layer 16, the liquid crystal compounds 40 having different positions in the thickness direction are arranged such that the major axis directions thereof face the same direction.

Further, as shown in FIG. 12, the liquid crystal compounds 40 in the cholesteric liquid crystal layer 16 are aligned to have a helical structure (cholesteric liquid crystalline phase) in which the liquid crystal compounds 40 are helically turned and laminated in order from the liquid crystal compounds 40 on the alignment film 14 side in a direction perpendicular to the major axis direction of the liquid crystal compound 40. In this case, the liquid crystal compounds 40 on the alignment film 14 side are tilted with respect to the surface of the cholesteric liquid crystal layer 16. Therefore, the helical axis of the helical structure of the cholesteric liquid crystalline phase is tilted with respect to the thickness direction of the cholesteric liquid crystal layer 16. In addition, the liquid crystal compounds 40 other than the liquid crystal compound 40 on the alignment film 14 side are also tilted with respect to the surface of the cholesteric liquid crystal layer 16.

In addition, a plurality of the liquid crystal compounds 40 are arranged on one tilted surface, and the liquid crystal compounds 40 are aligned to the helical structure (cholesteric liquid crystalline phase) in order from each of the liquid crystal compound 40 on the alignment film 14 side having different positions in the thickness direction. Therefore, on the surface of the cholesteric liquid crystal layer 16 opposite to the alignment film 14, the directions of the major axis directions of the liquid crystal compounds 40 are different from each other (FIG. 14).

Accordingly, in a cross-section of the cholesteric liquid crystal layer 16 observed with a SEM, a stripe pattern including bright portions (bright lines) and dark portions (dark lines) derived from the cholesteric liquid crystalline phase is observed as shown in FIG. 8.

The bright portions and the dark portions of the cholesteric liquid crystalline phase are formed to connect the liquid crystal compounds 40 that are helically turned and in which the directions of the optical axes (major axis directions) match with each other in the turning direction. Therefore, as shown in FIG. 8, in the cholesteric liquid crystal layer 16, the bright portions and the dark portions derived from the cholesteric liquid crystalline phase observed in the cross-sectional SEM image are tilted with respect to the main surface of the cholesteric liquid crystal layer 16 opposite to the alignment film 14.

In the cholesteric liquid crystal layer 16, the bright portions and the dark portions derived from the cholesteric liquid crystalline phase are tilted with respect to the main surface of the cholesteric liquid crystal layer 16 opposite to the alignment film 14. Therefore, light incident into the cholesteric liquid crystal layer 16 is reflected from the reflecting surface as the surface that is tilted with respect to the main surface. For example, light incident from the direction perpendicular to the main surface of the cholesteric liquid crystal layer 16 is reflected in a direction that is tilted in the tilt direction of the bright portions and the dark portions. As a result, the optical element can diffract the incident light.

This way, in the manufacturing method according to the embodiment of the present invention, even in a case where the resin layer 13 having the unevenness shape is formed and the alignment film 14 is formed on the resin layer 13, the unevenness shape can be imparted to the alignment film by transfer. Therefore, the manufacturing is easy, the manufacturing efficiency is high, and an increase in manufacturing time caused by an increase in size can be suppressed. In addition, a plurality of liquid crystal compounds are arranged on one tilted surface of the unevenness shape. Therefore, it is not necessary to change the alignment direction for each fine region, and the liquid crystal compounds can be suitably aligned without forming a fine alignment pattern. Therefore, the liquid crystal compounds in the cholesteric liquid crystal layer can be appropriately aligned with high accuracy.

In FIG. 9, the resin layer having the unevenness shape is formed on the support. However, the resin layer may also function as the support. In addition, the resin layer may have the function of the alignment film, and the resin layer may be directly aligned.

Here, in the example shown in FIG. 4, in a case where a cross-section parallel to the periodic direction of the unevenness shape is observed, the protrusion portion of the unevenness shape in the alignment film 14 has the shape in which the right angle apex is on the support 12 side such that the side opposite to the right angle of the right angled triangular shape is the tilted surface. However, the present invention is not limited to this configuration, and the protrusion portion of the unevenness shape in the alignment film 14 may be any shape that has a tilted surface and in which the unevenness shape is periodically formed.

For example, as shown in FIG. 13, the unevenness shape in the alignment film 14 may have a shape in which the right angle apex of the right angled triangle is opposite to the support 12. In addition, the protrusion portion of the unevenness shape in the alignment film 14 does not need to be a right angled triangular shape.

In addition, in the example shown in FIG. 4 or the like, the tilted surface of the unevenness shape in the alignment film 14 has a linear shape in a cross-section parallel to the periodic direction of the unevenness shape. However, the present invention is not limited to this configuration, and the tilted surface of the unevenness shape may have a curved shape. From the viewpoint that the liquid crystal compound can be suitably aligned, the shape of the tilted surface is preferably a linear shape in the cross-section parallel to the periodic direction of the unevenness shape.

Here, in the manufacturing method according to the embodiment of the present invention, the liquid crystal composition may include, as the chiral agent, any one selected from the group consisting of a chiral agent X in which a helical twisting power changes due to light irradiation and a chiral agent Y in which a helical twisting power changes due to a temperature change, and the liquid crystal layer forming step may include a step of changing the helical twisting power of the chiral agent due to light irradiation or heating.

By performing the two-step exposure using the chiral agent in which the HTP decreases due to light irradiation, one helical pitch (pitch P) is extended in the first exposure step, and the liquid crystal composition is cured in the second exposure step. As a result, the liquid crystal compound 40 can be stably tilted with respect to the main surface in the upper region, that is, in the region spaced from the alignment film 14.

By performing the exposure step twice, the cholesteric liquid crystal layer 16 can be controlled to have a configuration where, in a cross-section observed with a SEM, a region where the formation period of the bright portions and the dark portions, that is, the pitch P varies depending on positions in the thickness direction is provided.

In addition, by performing the exposure step twice, the cholesteric liquid crystal layer 16 can be controlled to have a configuration where a region where the tilt angle θ₁ of the bright portions and the dark portions varies depending on positions in the thickness direction is provided. The tilt angle θ₁ refers to an angle of the bright portions and the dark portions with respect to the main surface of the cholesteric liquid crystal layer 16 as shown in FIG. 8.

The cholesteric liquid crystal layer 16 may have a region where the tilt angle θ₁ continuously increases or decreases in one thickness direction. The cholesteric liquid crystal layer 16 may have a region where the tilt angle θ₁ continuously increases or decreases from the alignment film 14 side to the side (air side interface A) away from the alignment film 14.

The light used for the exposure is not particularly limited, and it is preferable to use ultraviolet light. The wavelength of irradiated ultraviolet light is preferably 250 to 430 nm.

The total irradiation energy is preferably 2 mJ/cm² to 50 J/cm² and more preferably 5 to 1500 mJ/cm². In order to promote a photopolymerization reaction, the exposure may be performed under heating conditions or in a nitrogen atmosphere.

In the manufacturing method according to the embodiment of the present invention, the cholesteric liquid crystal layer may be formed by applying the liquid crystal composition once or by repeating the application of the liquid crystal composition multiple times.

[Optical Element]

The optical element according to the embodiment of the present invention comprises:

a support;

an alignment film that is formed on the support; and

a liquid crystal layer that is formed on the alignment film and is formed of a liquid crystal composition including a liquid crystal compound,

in which a surface of the alignment film on the liquid crystal layer side has a periodic unevenness shape having a tilted surface that is tilted with respect to a surface of the support,

the liquid crystal compound in the liquid crystal layer is tilted with respect to the surface of the support, and

in a cross-section of the liquid crystal layer observed with a scanning electron microscope, bright portions and dark portions derived from the liquid crystal layer are tilted with respect to a main surface of the liquid crystal layer opposite to the alignment film.

The optical element according to the embodiment of the present invention may be the optical element that is manufactured using the above-described manufacturing method according to the embodiment of the present invention.

As described above, the optical element 10 according to the embodiment of the present invention includes the support 12, the alignment film 14, and the cholesteric liquid crystal layer 16.

<Alignment Film>

As described above, the surface of the alignment film 14 on the cholesteric liquid crystal layer 16 side has a periodic unevenness shape having a tilted surface that is tilted with respect to a surface of the support 12.

The alignment film 14 may have a configuration in which the unevenness shape is imparted to the alignment film 14 as shown in FIG. 6, or may have a configuration in which the unevenness shape is formed on the surface of the alignment film 14 by forming the alignment film 14 on the resin layer 13 having the unevenness shape as shown in FIG. 11.

<Cholesteric Liquid Crystal Layer>

The cholesteric liquid crystal layer has a helical structure in which the liquid crystal compound 40 is helically turned and laminated obtained by immobilizing a typical cholesteric liquid crystalline phase. In the helical structure, a configuration in which the liquid crystal compound 40 is helically turned once (rotated by 360) and laminated is set as one helical pitch, and one or more pitches of the helically turned liquid crystal compound 40 are laminated.

In other words, one helical pitch refers to the length of one helical winding, that is, the length in a helical axis direction in which a director (in a rod-shaped liquid crystal, a major axis direction) of the liquid crystal compound constituting the cholesteric liquid crystalline phase rotates by 360°.

Here, as described above, in the cholesteric liquid crystal layer 16, as shown in FIG. 7, the liquid crystal compound 40 on the alignment film 14 side is aligned in one in-plane direction depending on the alignment treatment that is performed on the alignment film 14.

In addition, the liquid crystal compound 40 on the alignment film 14 side is aligned to be parallel to the tilted surface of the protrusion portion 15 of the alignment film 14. Therefore, the major axis direction of the liquid crystal compound 40 is tilted with respect to the main surface of the cholesteric liquid crystal layer 16 (the main surface opposite to the alignment film 14).

In addition, as shown in FIG. 7, a plurality of the liquid crystal compounds 40 are arranged on one tilted surface. Therefore, regarding the liquid crystal compounds 40 on the alignment film 14 side in the cholesteric liquid crystal layer 16, the liquid crystal compounds 40 having different positions in the thickness direction are arranged such that the major axis directions thereof face the same direction.

Further, as shown in FIG. 7, the liquid crystal compounds 40 in the cholesteric liquid crystal layer 16 are aligned to have a helical structure (cholesteric liquid crystalline phase) in which the liquid crystal compounds 40 are helically turned and laminated in order from the liquid crystal compounds 40 on the alignment film 14 side in a direction perpendicular to the major axis direction of the liquid crystal compound 40. In this case, the liquid crystal compounds 40 on the alignment film 14 side are tilted with respect to the surface of the cholesteric liquid crystal layer 16. Therefore, the helical axis of the helical structure of the cholesteric liquid crystalline phase is tilted with respect to the thickness direction of the cholesteric liquid crystal layer 16. In addition, the liquid crystal compounds 40 other than the liquid crystal compound 40 on the alignment film 14 side are also tilted with respect to the surface of the cholesteric liquid crystal layer 16.

In addition, a plurality of the liquid crystal compounds 40 are arranged on one tilted surface, and the liquid crystal compounds 40 are aligned to the helical structure (cholesteric liquid crystalline phase) in order from the liquid crystal compound 40 on the alignment film 14 side having different positions in the thickness direction. Therefore, on the surface of the cholesteric liquid crystal layer 16 opposite to the alignment film 14, the directions of the major axis directions of the liquid crystal compounds 40 are different from each other.

FIG. 14 is a plan view conceptually showing the surface side of the cholesteric liquid crystal layer 16 opposite to the alignment film 14.

The plan view is a view in a case where the cholesteric liquid crystal layer 16 (optical element 10) is seen from the top in FIG. 7, that is, a view in a case where the optical element 10 is seen from a thickness direction (laminating direction of the respective layers (films)).

In addition, in FIG. 14, in order to clarify the configuration of the cholesteric liquid crystal layer 16, only the liquid crystal compound 40 on the surface (air side surface) opposite to the alignment film 14 is shown.

As shown in FIG. 14, on the air side surface, the liquid crystal compound 40 forming the cholesteric liquid crystal layer 16 is two-dimensionally arranged in the periodic direction of the unevenness shape of the alignment film 14 indicated by an arrow X and in a direction (the width direction of the protrusion portion) perpendicular to the periodic direction (arrow X direction).

In the following description, the direction perpendicular to the arrow X direction will be referred to as “Y direction” for convenience of description. That is, in FIGS. 7 and 13, the Y direction is a direction perpendicular to the paper plane.

In addition, the liquid crystal compound 40 forming the cholesteric liquid crystal layer 16 has the liquid crystal alignment pattern in which the direction of the optical axis 40A changes while continuously rotating in the arrow X direction in a plane of the cholesteric liquid crystal layer 16. In the example shown in the drawing, the liquid crystal compound 40 has the liquid crystal alignment pattern in which the optical axis 40A of the liquid crystal compound 40 changes while continuously rotating counterclockwise in the arrow X direction.

In the following description, “the direction of the optical axis 40A rotates” will also be simply referred to as “the optical axis 40A rotates”.

Specifically, “the direction of the optical axis 40A of the liquid crystal compound 40 changes while continuously rotating in the arrow X direction (the periodic direction of the unevenness shape)” represents that an angle between the optical axis 40A of the liquid crystal compound 40, which is arranged in the arrow X direction, and the arrow X direction varies depending on positions in the arrow X direction, and the angle between the optical axis 40A and the arrow X direction sequentially changes from θ to θ+180° or θ−180° in the arrow X direction.

A difference between the angles of the optical axes 40A of the liquid crystal compound 40 adjacent to each other in the arrow X direction is preferably 45° or less, more preferably 15° or less, and still more preferably less than 15°.

On the other hand, in the liquid crystal compound 40 forming the cholesteric liquid crystal layer 16, the directions of the optical axes 40A are the same in the Y direction perpendicular to the arrow X direction, that is, the Y direction perpendicular to the one in-plane direction in which the optical axis 40A continuously rotates.

In other words, in the liquid crystal compound 40 forming the cholesteric liquid crystal layer 16, angles between the optical axes 40A of the liquid crystal compound 40 and the arrow X direction are the same in the Y direction.

In the optical element 10 according to the embodiment of the present invention, in the liquid crystal alignment pattern of the liquid crystal compound 40, the length (distance) over which the optical axis 40A of the liquid crystal compound 40 rotates by 180° in the arrow X direction in which the optical axis 40A changes while continuously rotating in a plane is the length Λ of the single period in the liquid crystal alignment pattern. That is, a distance between centers of two liquid crystal compounds 40 in the arrow X direction is the length Λ of the single period, the two liquid crystal compounds having the same angle in the arrow X direction.

Specifically, as shown in FIG. 14, a distance of centers in the arrow X direction of two liquid crystal compounds 40 in which the arrow X direction and the direction of the optical axis 40A match each other is the length Λ of the single period. In the following description, the length Λ of the single period will also be referred to as “single period Λ”.

In the optical element 10 according to the embodiment of the present invention, in the liquid crystal alignment pattern of the cholesteric liquid crystal layer, the single period Λ is repeated in the arrow X direction, that is, in the one in-plane direction in which the direction of the optical axis 40A changes while continuously rotating.

In addition, in FIG. 14, the alignment pattern of the liquid crystal compound 40 on the surface of the cholesteric liquid crystal layer 16 opposite to the alignment film 14 is shown. However, the arrangement of the liquid crystal compound 40 at a position of a cross-section in the thickness direction of the cholesteric liquid crystal layer 16 (that is, a cross-section perpendicular to the thickness direction) changes while continuously rotating in the arrow X direction (the periodic direction of the unevenness shape) as in the arrangement pattern shown in FIG. 14, and the liquid crystal compound 40 is arranged in the Y direction in an alignment pattern in which the direction of the optical axis 40A is uniform.

Here, in a cross-section of the cholesteric liquid crystal layer 16 observed with a SEM, a stripe pattern including bright portions (bright lines) and dark portions (dark lines) derived from the cholesteric liquid crystalline phase is observed as shown in FIG. 8.

The bright portions and the dark portions of the cholesteric liquid crystalline phase are formed to connect the liquid crystal compounds 40 that are helically turned and in which the directions of the optical axes (major axis directions) match with each other in the turning direction. Therefore, as shown in FIG. 8, in the cholesteric liquid crystal layer 16, the bright portions and the dark portions derived from the cholesteric liquid crystalline phase observed in the cross-sectional SEM image are tilted with respect to the main surface of the cholesteric liquid crystal layer 16 opposite to the alignment film 14.

In the cholesteric liquid crystal layer 16 of the optical element according to the embodiment of the present invention, the bright portions and the dark portions derived from the cholesteric liquid crystalline phase are tilted with respect to the main surface of the cholesteric liquid crystal layer 16 opposite to the alignment film 14. Therefore, light incident into the cholesteric liquid crystal layer 16 is reflected from the reflecting surface as the surface that is tilted with respect to the main surface. For example, light incident from the direction perpendicular to the main surface of the cholesteric liquid crystal layer 16 is reflected in a direction that is tilted in the tilt direction of the bright portions and the dark portions. As a result, the optical element 10 according to the embodiment of the present invention can diffract the incident light.

In addition, in the optical element according to the embodiment of the present invention, the liquid crystal compound 40 of the cholesteric liquid crystal layer 16 is aligned along the tilted surface of the unevenness shape in the alignment film 14 and is tilted with respect to the surface of the cholesteric liquid crystal layer 16. Therefore, the direction of the tilt of the liquid crystal compound 40 can be made to substantially match the direction of the tilt of the bright portions and the dark portion of the cholesteric liquid crystalline phase. As a result, the action of the liquid crystal compound on light reflection (diffraction) increases, the diffraction efficiency can be improved, and the amount of reflected light with respect to incidence light can be further improved.

In the cholesteric liquid crystalline phase, a structure in which the bright portion and the dark portion are repeated twice corresponds to one helical pitch. The structure in which the bright portion B and the dark portion D are repeated twice includes three dark portions (bright portions) and two bright portions (dark portions). Therefore, one helical pitch (pitch P) of the cholesteric liquid crystal layer, that is, the reflective layer can be measured from the cross-sectional SEM image.

<<Cholesteric Liquid Crystalline Phase>>

It is known that the cholesteric liquid crystalline phase exhibits selective reflectivity at a specific wavelength.

A center wavelength of selective reflection (selective reflection center wavelength) λ of a general cholesteric liquid crystalline phase depends on the length of one helical pitch in the cholesteric liquid crystalline phase and complies with a relationship of λ=n×P with an average refractive index n of the cholesteric liquid crystalline phase. Therefore, the selective reflection center wavelength can be adjusted by adjusting the helical pitch.

The selective reflection center wavelength of the cholesteric liquid crystalline phase increases as the pitch P increases.

The helical pitch of the cholesteric liquid crystalline phase depends on the kind of the chiral agent used together with the liquid crystal compound and the concentration of the chiral agent added during the formation of the cholesteric liquid crystal layer. Therefore, a desired helical pitch can be obtained by adjusting these conditions.

The details of the adjustment of the pitch can be found in “Fuji Film Research & Development” No. 50 (2005), pp. 60 to 63. As a method of measuring a helical sense and a helical pitch, a method described in “Introduction to Experimental Liquid Crystal Chemistry”, (the Japanese Liquid Crystal Society, 2007, Sigma Publishing Co., Ltd.), p. 46, and “Liquid Crystal Handbook” (the Editing Committee of Liquid Crystal Handbook, Maruzen Publishing Co., Ltd.), p. 196 can be used.

The cholesteric liquid crystalline phase exhibits selective reflectivity with respect to left or circularly polarized light at a specific wavelength. Whether or not the reflected light is right circularly polarized light or left circularly polarized light is determined depending on a helical twisted direction (sense) of the cholesteric liquid crystalline phase. Regarding the selective reflection of the circularly polarized light by the cholesteric liquid crystalline phase, in a case where the helical twisted direction of the cholesteric liquid crystal layer is right, right circularly polarized light is reflected, and in a case where the helical twisted direction of the cholesteric liquid crystal layer is left, left circularly polarized light is reflected.

A twisted direction of the cholesteric liquid crystalline phase can be adjusted by adjusting the kind of the liquid crystal compound that forms the cholesteric liquid crystal layer and/or the kind of the chiral agent to be added.

In addition, a half-width Δλ (nm) of a selective reflection wavelength range (circularly polarized light reflection wavelength range) where selective reflection is exhibited depends on Δn of the cholesteric liquid crystalline phase and the helical pitch P and complies with a relationship of Δλ=Δn×P. Therefore, the width of the selective reflection wavelength range can be controlled by adjusting Δn. Δn can be adjusted by adjusting a kind of a liquid crystal compound for forming the cholesteric liquid crystal layer and a mixing ratio thereof, and a temperature during alignment immobilization.

The half-width of the reflection wavelength range is adjusted depending on the application of the optical laminate and may be, for example, 10 to 500 nm and is preferably 20 to 300 nm and more preferably 30 to 100 nm.

As described above, the cholesteric liquid crystal layer 16 reflects right circularly polarized light or left circularly polarized light in a selective wavelength range.

Accordingly, in a case where light is incident into the cholesteric liquid crystal layer 16, the cholesteric liquid crystal layer 16 reflects only right circularly polarized light or left circularly polarized light in the selective wavelength range and allows transmission of the other light.

Here, in the typical cholesteric liquid crystal layer in which the bright portions and the dark portions derived from the cholesteric liquid crystalline phase are parallel to the surface of the cholesteric liquid crystal layer, incident circularly polarized light is reflected by specular reflection.

On the other hand, in the cholesteric liquid crystal layer 16 in the optical element according to the embodiment of the present invention in which the bright portions and the dark portions derived from the cholesteric liquid crystalline phase are tilted with respect to the surface of the cholesteric liquid crystal layer, as described above, circularly polarized light is reflected in a direction tilted in the arrow X direction with respect to specular reflection.

Hereinafter, this point will be described.

Hereinafter, in the following description, it is assumed that the cholesteric liquid crystal layer 16 reflects right circularly polarized light.

In a case where the right circularly polarized light incident into the cholesteric liquid crystal layer 16 is reflected from the cholesteric liquid crystal layer, the absolute phase changes depending on the directions of the optical axes 40A of the respective liquid crystal compounds 40.

Here, in the cholesteric liquid crystal layer 16, the optical axis 40A of the liquid crystal compound 40 changes while rotating in the arrow X direction (the one in-plane direction). Therefore, the amount of change in the absolute phase of the incident right circularly polarized light varies depending on the direction of the optical axis 40A.

Further, the liquid crystal alignment pattern formed in the cholesteric liquid crystal layer 16 is a pattern that is periodic in the arrow X direction. Therefore, an absolute phase that is periodic in the arrow X direction corresponding to the direction of each of the optical axes 40A is assigned to the right circularly polarized light R incident into the cholesteric liquid crystal layer 16.

In addition, the direction of the optical axis 40A of the liquid crystal compound 40 with respect to the arrow X direction is uniform in the arrangement of the liquid crystal compound 40 in the Y direction perpendicular to arrow X direction.

As a result, in the cholesteric liquid crystal layer 16, an equiphase surface that is tilted to rise in the arrow X direction with respect to an XY plane is formed for the right circularly polarized light. The equiphase surface is formed to connect the liquid crystal compounds 40 that are helically turned and in which the directions of the optical axes 40A match with each other in the turning direction.

In a cross-section of the cholesteric liquid crystalline phase observed with a SEM, a stripe pattern including bright portions and dark portions derived from the cholesteric liquid crystalline phase is observed.

As is well known, the bright portions and the dark portions of the cholesteric liquid crystalline phase are formed to connect the liquid crystal compounds 40 that are helically turned and in which the directions of the optical axes 40A match with each other in the turning direction. That is, the bright portions and the dark portions match with the above-described equiphase surface.

Here, bright portions and dark portions of a typical cholesteric liquid crystal layer are parallel to the main surface, that is, the alignment surface that is the formation surface.

On the other hand, the cholesteric liquid crystal layer 16 has the liquid crystal alignment pattern in which the optical axis 40A continuously rotates in the arrow X direction in a plane, and as conceptually shown in FIG. 8, the bright portions and the dark portions of the cholesteric liquid crystal layer 16 are tilted to rise in the arrow X direction with respect to the main surface according to the arrangement of the liquid crystal compounds 40A in which the directions of the optical axes 40 match with each other in the helical turning direction.

Therefore, right circularly polarized light incident from the liquid crystal layer side is reflected in a direction that is tilted in a direction opposite to the arrow X direction with respect to the XY plane (the main surface of the cholesteric liquid crystal layer), that is, in the tilt direction of the tilted surface of the unevenness shape in the alignment film 14.

The tilt angle θ₁ (refer to FIG. 8) of the bright portions and the dark portions of the cholesteric liquid crystal layer 16 substantially matches the tilt angle θ₀ of the tilted surface of the unevenness shape in the alignment film 14. Accordingly, the tilt angle θ₁ (refer to FIG. 8) of the bright portions and the dark portions of the cholesteric liquid crystal layer 16 can be adjusted by setting the tilt angle θ₀ of the tilted surface of the unevenness shape in the alignment film 14.

The tilt angle θ₁ of the bright portions and the dark portions of the cholesteric liquid crystal layer 16 may be different from the tilt angle θ₀ of the tilted surface of the unevenness shape in the alignment film 14.

Here, in the optical element according to the embodiment of the present invention, in a case where an in-plane retardation Re of the cholesteric liquid crystal layer 16 is measured from a direction tilted with respect to a normal direction and a normal line, it is preferable that an absolute value of a measured angle of a direction in which the in-plane retardation Re is minimum in any one of a slow axis plane or a fast axis plane with respect to the normal line is 5° or more. In other words, it is preferable that the liquid crystal compound of the cholesteric liquid crystal layer is tilted with respect to the main surface and the tilt direction substantially matches with the bright portions and the dark portions of the cholesteric liquid crystalline phase. The normal direction is a direction perpendicular to the main surface.

By the cholesteric liquid crystal layer having the above-described configuration, circularly polarized light can be diffracted with a higher diffraction efficiency than the cholesteric liquid crystal layer in which the bright portions and the dark portions of the cholesteric liquid crystalline phase are tilted with respect to the main surface the liquid crystal compound is parallel to the main surface.

In the configuration where the liquid crystal compound of the cholesteric liquid crystal layer is tilted with respect to the main surface and the tilt direction substantially matches with the bright portions and the dark portions of the cholesteric liquid crystalline phase, bright portions and dark portions corresponding to a reflecting surface match with the optical axis of the liquid crystal compound. Therefore, the action of the liquid crystal compound on light reflection (diffraction) increases, the diffraction efficiency can be improved. As a result, the amount of reflected light with respect to incidence light can be further improved.

In a fast axis plane or a slow axis plane of the cholesteric liquid crystal layer, the absolute value of the optical axis tilt angle of the cholesteric liquid crystal layer is 5° or more, preferably 15° or more, and more preferably 20° or more.

It is preferable that the absolute value of the optical axis tilt angle is 15° or more from the viewpoint that the direction of the liquid crystal compound matches the bright portions and the dark portions more suitably such that the diffraction efficiency can be improved.

The above-described optical element 10 includes only one cholesteric liquid crystal layer 16, but the present invention is not limited thereto. That is, the liquid crystal diffraction element including the cholesteric liquid crystal layer may include two or more cholesteric liquid crystal layers.

For example, the optical element that is used as the liquid crystal diffraction element may include two cholesteric liquid crystal layers including a cholesteric liquid crystal layer that selectively reflects red light and a cholesteric liquid crystal layer that selectively reflects green light, and may include three cholesteric liquid crystal layers including a cholesteric liquid crystal layer that selectively reflects red light, a cholesteric liquid crystal layer that selectively reflects green light, and a cholesteric liquid crystal layer that selectively reflects blue light.

In a case where the liquid crystal diffraction element includes a plurality of cholesteric liquid crystal layers, it is preferable that all the cholesteric liquid crystal layers are the cholesteric liquid crystal layers 16 in the optical element according to the embodiment of the present invention, and a typical cholesteric liquid crystal layer other than the cholesteric liquid crystal layer 16 in the optical element according to the embodiment of the present invention may be included.

The optical element according to the embodiment of the present invention can be used for various uses where light is reflected at an angle other than the angle of specular reflection, for example, an optical path changing member, a light collecting element, a light diffusing element to a predetermined direction, a diffraction element, or the like in an optical device.

In addition, in the above-described example, the liquid crystal layer is the cholesteric liquid crystal layer, but the present invention is not limited thereto. The liquid crystal compound may be gently twisted and aligned in the thickness direction without being cholesterically aligned.

In this configuration, the liquid crystal compound in the liquid crystal layer is tilted with respect to the surface of the support along the tilted surface of the alignment film, the bright portions and the dark portions in the cross-sectional SEM image derived from the gentle twisted alignment are observed, and the bright portions and the dark portions are tilted with respect to the main surface of the liquid crystal layer opposite to the alignment film.

Even in this configuration, on the surface of the liquid crystal layer 16 opposite to the alignment film 14, the direction of the major axis direction of the liquid crystal compound 40 changes while continuously rotating in the arrow X direction (the periodic direction of the unevenness shape), and the liquid crystal compound 40 is arranged in the Y direction in an alignment pattern in which the direction of the optical axis 40A is uniform. Likewise, the arrangement of the liquid crystal compound 40 at a position of a cross-section in the thickness direction of the liquid crystal layer 16 (that is, a cross-section perpendicular to the thickness direction) changes while continuously rotating in the arrow X direction (the periodic direction of the unevenness shape) as in the arrangement pattern shown in FIG. 14, and the liquid crystal compound 40 is arranged in the Y direction in an alignment pattern in which the direction of the optical axis 40A is uniform.

In a case where circularly polarized light is incident into the above-described liquid crystal layer, the light is diffracted and transmitted in a state where the direction of the circularly polarized light is converted.

This action will be described below. In the liquid crystal layer, the value of the product of the difference in refractive index of the liquid crystal compound and the thickness of the liquid crystal layer is λ/2.

In a case where the value of the product of the difference in refractive index of the liquid crystal compound in the liquid crystal layer and the thickness of the liquid crystal layer is λ/2 and incidence light as left circularly polarized light is incident into the liquid crystal layer, the incidence light transmits through the liquid crystal layer to be imparted with a phase difference of 180°, and the transmitted light is converted into right circularly polarized light.

In addition, in a case where the incidence light transmits through the liquid crystal layer, an absolute phase thereof changes depending on the direction of the optical axis of each of the liquid crystal compounds. In this case, the direction of the optical axis changes while rotating in the arrow X direction. Therefore, the amount of change in the absolute phase of the incidence light varies depending on the direction of the optical axis. Further, the alignment pattern that is formed in the liquid crystal layer is a pattern that is periodic in the arrow X direction. Therefore, the incidence light transmitted through the liquid crystal layer is imparted with an absolute phase that is periodic in the arrow X direction corresponding to the direction of each of the optical axes. As a result, an equiphase surface that is tilted in the arrow X direction is formed.

Therefore, the transmitted light is diffracted to be tilted in a direction perpendicular to the equiphase surface and travels in a direction different from a traveling direction of the incidence light. This way, the incidence light of the left circularly polarized light is converted into the transmitted light of right circularly polarized light that is tilted by a predetermined angle in the arrow X direction with respect to an incidence direction.

In a case where the incidence light is right circularly polarized light, the incidence light is diffracted in a direction opposite to that of the left circularly polarized light and is converted into transmitted light of left circularly polarized light.

Hereinabove, the optical element and the method of manufacturing an optical element according to the embodiment of the present invention have been described in detail. However, the present invention is not limited to the above-described examples, and various improvements and modifications can be made within a range not departing from the scope of the present invention.

### EXAMPLES

Hereinafter, the characteristics of the present invention will be described in detail using examples. Materials, chemicals, used amounts, material amounts, ratios, treatment details, treatment procedures, and the like shown in the following examples can be appropriately changed within a range not departing from the scope of the present invention. Accordingly, the scope of the present invention is not limited to the following specific examples.

### Example 1

<Preparation of Resin Layer>

A photocurable resin (manufactured by Toyo Gosei Co., Ltd. PAK-02) as a resin film was applied to a triacetyl cellulose (TAC) film (manufactured by Fujifilm Corporation, FUJITAC) as a support. A transfer mold where an uneven structure in which the period was 0.8 μm and the tilt angle of the tilted surface was 36° was periodically formed was released. The applied photocurable resin layer (coating layer) was pressed using a stamper. As a result, the uneven structure of the stamper was transferred to the coating layer. Next, in a state where the stamper was pressed, the coating layer was irradiated with ultraviolet light having a wavelength of 365 nm at an illuminance of 20 mW/cm² for 60 seconds to be cured. Next, the stamper was slowly released, and the resin layer having the uneven structure on the TAC film was obtained.

<Preparation of Alignment Film>

The following coating solution for forming a photo-alignment film was applied to the prepared resin layer by spin coating. The support on which the coating film of the coating solution for forming a photo-alignment film was formed was dried using a hot plate at 60° C. for 60 seconds. As a result, a photo-alignment film was formed.

Coating Solution for Forming Alignment Film

| | |
|---|---|
| The following material for photo-alignment | 1.00 part by mass |
| Water | 16.00 parts by mass |
| Butoxyethanol | 42.00 parts by mass |
| Propylene glycol monomethyl ether | 42.00 parts by mass |

Material for Photo-Alignment

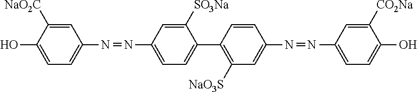

(Exposure of Alignment Film)

By irradiating the obtained alignment film obtained by forming the photo-alignment film with polarized ultraviolet light (20 mJ/cm², using an extra high pressure mercury lamp), the alignment film was exposed.

The surface of the alignment layer obtained as described above was observed with a SEM (manufactured by Hitachi, Ltd., S-4800), and it was found that the uneven structure of the stamper was transferred to the alignment layer. That is, the alignment film having the unevenness shape where the period was 0.8 μm and the tilt angle of the tilted surface was 36° was obtained.

<Preparation of Liquid Crystal Composition>

<<Chiral Agent>>

(Synthesis of Compound CD-1)

According to the following synthesis procedure, the compound CD-1 was synthesized using a general method.

The compound CD-1 is a chiral agent in which the helix direction is left and the helical twisting power does not change due to a temperature change or light irradiation.

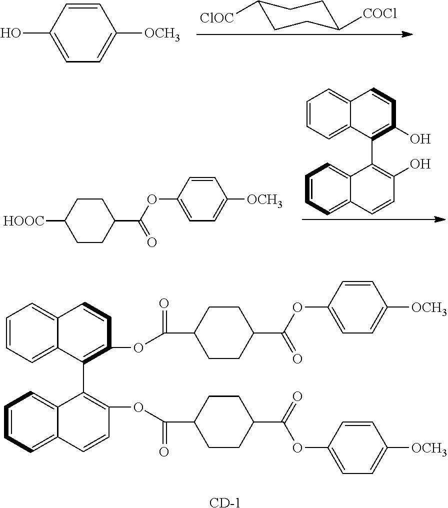

(Synthesis of Compound CD-2)

The following compound CD-2 was synthesized according to JP2002-338575A and used.

The compound CD-2 is a chiral agent in which the helical direction is right and the helical twisting power changes due to a temperature change or light irradiation.

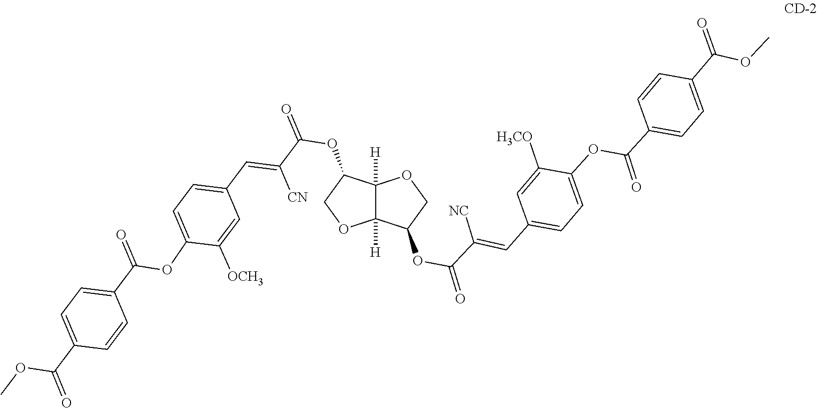

<<Surfactant S-1>>

As the surfactant, the following surfactant S-1 was used.

The surfactant S-1 is a compound described in JP5774518B and has the following structure.

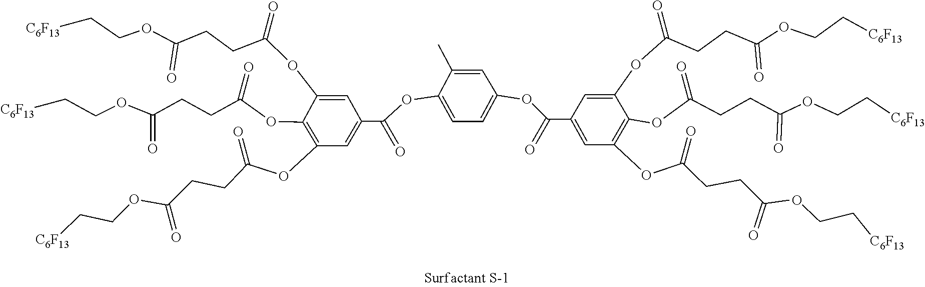

As the liquid crystal composition, the following composition A-1 was prepared.

Composition A-1

| | |
|---|---|
| Liquid crystal compound L-1 | 100.00 parts by mass |
| Compound S-1 | 0.1 parts by mass |
| Compound CD-1 | 5.5 parts by mass |
| Compound CD-2 | 5.5 parts by mass |
| Initiator Irg-907 (manufactured by BASF SE) | 2.0 parts by mass |

Solvent (MEK (Methyl ethyl ketone)/cyclohexanone = 90/10 (mass ratio))
An amount in which the solute concentration was 30 mass %
Liquid Crystal Compound L-1

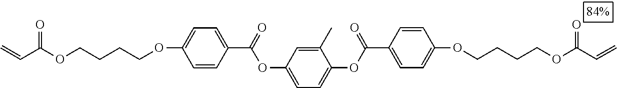 [SMILES: C=CC(=O)OCCCCOc1ccc(C(=O)Oc2ccc(OC(=O)c3ccc(OCCCCOC(=O)C=C)cc3)c(C)c2)cc1]

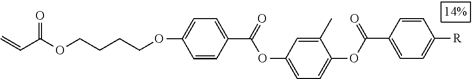

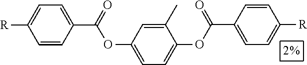

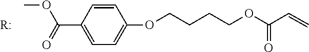

<<Preparation of Liquid Crystal Layer>>

The composition A-1 was applied to the alignment film to form a coating film, the coating film was heated using a hot plate at 90° C. for 1 minute. Next, the heated coating film was irradiated with light (ultraviolet light) having a wavelength of 365 nm at 30° C. using a light source (2 UV transilluminator, manufactured by UVP Inc.) at an irradiation intensity of 2 mW/cm² for 60 seconds. Next, the coating film was irradiated with ultraviolet light (UV) at 30° C. in a nitrogen atmosphere at an irradiation dose of 500 mJ/cm² to cause a polymerization reaction of the liquid crystal compound to occur. As a result, the liquid crystal layer in which the alignment state of the liquid crystal was immobilized was obtained.

In a case where a cross-section of the prepared liquid crystal layer was observed with a scanning electron microscope (SEM), it was verified that an arrangement direction of bright portions and dark portions derived from a liquid crystal phase was tilted in one in-plane direction with respect to a main surface (air interface side surface) of the liquid crystal layer on the air interface side.

While changing the incidence angle of light to be measured in a plane parallel to the periodic direction of the alignment layer, a retardation Re was measured using “Axoscan” (manufactured by Axometrics, Inc.). The measurement wavelength was set to 750 nm. In addition, the incidence angle of the light to be measured was set to a range of −70° to 70°. The average refractive index of the liquid crystal layer was 1.5, and the absolute value of the optical axis tilt angle φ was obtained from “sin θ2=n·sin φ” based on the measured angle θ2 as the angle of the direction in which the in-plane retardation was minimum with respect to the normal line (the normal line on the main surface of the liquid crystal layer on the air interface side). As a result, the optical axis tilt angle φ was 35°. The result shows that the liquid crystal molecules are in the alignment state that is tilted with respect to the main surface of the liquid crystal layer on the air interface side.

[Evaluation of Reflection Angle]

In a case where light was incident into the prepared optical element from the front (direction with an angle of 0° with respect to the normal line), an angle (reflection angle) of reflected light with respect to the incidence light was measured.

Specifically, each of laser beams having an output center wavelength of 650 nm was caused to be vertically incident into the prepare optical element from a position at a distance of 50 cm in the normal direction, and reflected light was captured using a screen disposed at a distance of 50 cm to calculate a reflection angle. The incidence light was incident from the surface where the liquid crystal layer was formed. As a result, the reflection angle was 54°.

Based on the above results, it can be seen that, with the manufacturing method according to the embodiment of the present invention, the liquid crystal alignment pattern in which the direction of the optical axis derived from the liquid crystal compound changes while continuously rotating in at least one in-plane direction can be formed on the liquid crystal layer instead of forming the alignment pattern using the method such as the photoalignment method or the rubbing method. In the manufacturing method, as compared to the method in the related art such as the photoalignment method or the rubbing method, the alignment pattern can be formed with high manufacturing efficiency and high accuracy, and an increase in manufacturing time caused by an increase in size can be suppressed.

As can be seen from the above results, the effects of the present invention are obvious.

The present invention is suitably applicable to various uses where light is reflected in an optical device, for example, a diffraction element that causes light to be incident into a light guide plate of AR glasses or emits light to the light guide plate.

### EXPLANATION OF REFERENCES

10: liquid crystal diffraction element (optical element)

12: support

13: resin layer

14: alignment film

14a: alignment film on which unevenness shape is not yet formed

15, 15b: protrusion portion

16: cholesteric liquid crystal layer

40: liquid crystal compound

40A: optical axis

100: transfer mold

s: period of unevenness shape

h: height of protrusion portion

θ₀: tilt angle of tilted surface

θ₁: tilt angle of bright and dark lines

Λ: single period of liquid crystal alignment pattern

What is claimed is:

1. A method of manufacturing an optical element, the optical element including a liquid crystal layer that is formed of a liquid crystal composition including a liquid crystal compound, an alignment film that aligns the liquid crystal compound of the liquid crystal layer, and a support, the method comprising:
an alignment film forming step of forming the alignment film having a periodic unevenness shape on the support, the unevenness shape having a tilted surface that is tilted with respect to a surface of the support; and
a liquid crystal layer forming step of forming the liquid crystal layer on the alignment film.

2. The method of manufacturing an optical element according to claim 1,
wherein in the alignment film forming step, after applying an alignment material forming the alignment film to the support, the unevenness shape is transferred to the alignment material to form the alignment film having the unevenness shape.

3. The method of manufacturing an optical element according to claim 1,
wherein in the alignment film forming step, after forming a resin layer having the unevenness shape on the support, the alignment film is formed on the resin layer.

4. The method of manufacturing an optical element according to claim 1,
wherein a period of the unevenness shape of the alignment film that is formed in the alignment film forming step is 0.1 μm to 50 μm.

5. The method of manufacturing an optical element according to claim 1,
wherein a height of a protrusion portion of the unevenness shape of the alignment film is 0.05 μm to 20 μm.

6. The method of manufacturing an optical element according to claim 1,
wherein a tilt angle of the tilted surface of the unevenness shape of the alignment film is 3° to 80°.

7. The method of manufacturing an optical element according to claim 1,
wherein in the liquid crystal layer forming step, the liquid crystal composition includes the liquid crystal compound and a chiral agent, and a cholesteric liquid crystal layer is formed by cholesteric alignment of the liquid crystal compound.

8. The method of manufacturing an optical element according to claim 7,
wherein at least one chiral agent of the liquid crystal composition is any one selected from the group consisting of a chiral agent X in which a helical twisting power changes due to light irradiation and a chiral agent Y in which a helical twisting power changes due to a temperature change, and
the liquid crystal layer forming step includes a step of changing the helical twisting power of the chiral agent due to light irradiation or heating.

9. An optical element comprising:
a support;
an alignment film that is formed on the support; and
a liquid crystal layer that is formed on the alignment film and is formed of a liquid crystal composition including a liquid crystal compound,
wherein a surface of the alignment film on the liquid crystal layer side has a periodic unevenness shape having a tilted surface that is tilted with respect to a surface of the support,
the liquid crystal compound in the liquid crystal layer is tilted with respect to the surface of the support, and
in a cross-section of the liquid crystal layer observed with a scanning electron microscope, bright portions and dark portions derived from the liquid crystal layer are tilted with respect to a main surface of the liquid crystal layer opposite to the alignment film.

10. The optical element according to claim 9,
wherein the liquid crystal layer is a cholesteric liquid crystal layer obtained by cholesteric alignment of the liquid crystal compound.

11. The optical element according to claim 9,
wherein on the main surface of the liquid crystal layer opposite to the alignment film, a direction of a molecular axis of the liquid crystal compound changes while continuously rotating in one in-plane direction.

12. The optical element according to claim 9,
wherein in a case where a retardation is measured in a direction tilted with respect to a normal direction and a normal line of the main surface of the liquid crystal layer opposite to the alignment film,
an angle between a direction in which a value of retardation is minimum in any one of a slow axis plane or a fast axis plane and the normal direction is 5° or more.

13. The method of manufacturing an optical element according to claim 2,
wherein a period of the unevenness shape of the alignment film that is formed in the alignment film forming step is 0.1 μm to 50 μm.

14. The method of manufacturing an optical element according to claim 2,
wherein a height of a protrusion portion of the unevenness shape of the alignment film is 0.05 μm to 20 μm.

15. The method of manufacturing an optical element according to claim 2,
wherein a tilt angle of the tilted surface of the unevenness shape of the alignment film is 3° to 80°.

16. The method of manufacturing an optical element according to claim 2,
wherein in the liquid crystal layer forming step, the liquid crystal composition includes the liquid crystal compound and a chiral agent, and a cholesteric liquid crystal layer is formed by cholesteric alignment of the liquid crystal compound.

17. The method of manufacturing an optical element according to claim 15,
wherein at least one chiral agent of the liquid crystal composition is any one selected from the group consisting of a chiral agent X in which a helical twisting power changes due to light irradiation and a chiral agent Y in which a helical twisting power changes due to a temperature change, and
the liquid crystal layer forming step includes a step of changing the helical twisting power of the chiral agent due to light irradiation or heating.

18. The optical element according to claim 10,
wherein on the main surface of the liquid crystal layer opposite to the alignment film, a direction of a molecular axis of the liquid crystal compound changes while continuously rotating in one in-plane direction.

19. The optical element according to claim 10,
wherein in a case where a retardation is measured in a direction tilted with respect to a normal direction and a normal line of the main surface of the liquid crystal layer opposite to the alignment film,
an angle between a direction in which a value of retardation is minimum in any one of a slow axis plane or a fast axis plane and the normal direction is 5° or more.

20. The method of manufacturing an optical element according to claim 3,
wherein a period of the unevenness shape of the alignment film that is formed in the alignment film forming step is 0.1 μm to 50 μm.
